(19) United States
(12) Patent Application Publication
(10) Pub. No.: US 2026/0057738 A1
(43) Pub. Date: Feb. 26, 2026

(54) PROGRESSIVE AWARD GROWTH ASSOCIATED WITH A DISTRIBUTED LEDGER

(71) Applicant: IGT, Las Vegas, NV (US)

(72) Inventors: Michael Russ, Styria (AT); Stefan Keilwert, St. Josef (AT); Sven Aurich, Schwanberg (AT)

(21) Appl. No.: 18/815,478

(22) Filed: Aug. 26, 2024

(51) Int. Cl. G07F 17/32

(52) U.S. Cl. CPC G07F 17/3258

(57) ABSTRACT

Systems and methods that maintain a progressive award, cause, in a distributed ledger, an association of a token with the maintained progressive award, and if a progressive award increment event occurs, cause, in the distributed ledger, a modification associated with the token.

### BACKGROUND

In various embodiments, the systems and methods of the present disclosure maintain a progressive award, cause, in a distributed ledger, an association of a token with the maintained progressive award, and if a progressive award increment event occurs, cause, in the distributed ledger, a modification associated with the token.

Developing and maintaining a loyal customer base is one component of operating a successful gaming establishment. To develop a loyal customer base, gaming establishments, such as casinos, attempt to generate interactions with their patrons that provide a unique and personalized experience. As an example, gaming establishments offer patrons the opportunity to participate in a player loyalty program via which patrons are offered various promotions that encourage the patron to return to the gaming establishment.

### BRIEF DESCRIPTION OF THE FIGURES

FIG. 1 is an example configuration of the architecture of a plurality of different components of the system of the present disclosure.

FIGS. 2A and 2B are example graphical user interfaces displayed on a display device of an electronic gaming machine illustrating an association of a non-fungible token with a progressive award and the growth of the value of that progressive award resulting in a modification of an attribute of the associated non-fungible token.

FIG. 3 is an example sequence of graphical user interfaces displayed on a mobile device in connection with an amount of cryptocurrency pledged, for a limited duration, to fund a progressive award in exchange for a benefit.

FIG. 4 is a schematic block diagram of one embodiment of an electronic configuration of an example system of the present disclosure.

FIGS. 5A and 5B are perspective views of example alternative embodiments of the system of the present disclosure.

FIG. 5C is a front view of an example personal gaming device of the system of the present disclosure.

### DETAILED DESCRIPTION

In various embodiments, the systems and methods of the present disclosure maintain a progressive award, cause, in a distributed ledger, an association of a token with the maintained progressive award, and if a progressive award increment event occurs, cause, in the distributed ledger, a modification associated with the token.

In certain embodiments, the system employs one or more distributed ledger databases to supplement or otherwise enhance one or more awards, such as one or more progressive awards. In these embodiments, the system operates with one or more computing devices of one or more distributed ledgers to record, as one or more entries in such distributed ledgers, certain parameters of an award. These recorded parameters pertain to any aspects of an award, such as any contributions to the award, any distributions of the award, any digital currencies associated with the award, any digital assets associated with the award, and/or any modifications of such recorded parameters. Such a configuration enables a gaming establishment to take advantage of one or more distributed ledgers to not only track one or more instances of one or more events occurring (or not occurring) in association with one or more available awards, but also introduce additional features and functionality not otherwise available due to the centralized management of certain aspects of gaming establishment awards.

In certain embodiments of utilizing one or more distributed ledger entries to enhance one or more characteristics of a progressive award, the system employs a distributed ledger, such as a blockchain, to store certain data associated with one or more progressive awards. In these embodiments, the system utilizes the data stored on the distributed ledger to potentially alter the gaming experience, in relation to the progressive award, of one or more users of one or more gaming devices. In such embodiments, the system operates with one or more computing devices associated with a distributed ledger to track data associated with a progressive award. In these embodiments, upon a progressive award contribution event, the system increases a value of the progressive award and interfaces with such computing devices to record part or all of such an event on the distributed ledger. For example, the system maintains one or more progressive awards in association with a blockchain and upon a wager placed on a play of a game that results in a portion of that wager contributing to the progressive award (i.e., a progressive award contribution event), the system increases the value of the progressive award and utilizes the blockchain to record at least the contribution amount and an identity of a user associated with the contribution amount.

In addition to employing a distributed ledger to track different aspects of the progressive award, in certain embodiments, upon a progressive award triggering event, in addition to causing part or all of progressive award to be provided to a user associated with winning the progressive award, the system utilizes the entries of the distributed ledger to provide a benefit to zero, one or more additional users. In certain such embodiments, the system employs the tracked contributions to the progressive award from various users to offer a benefit includes providing certain of such users a supplemental award in association with such contributions. For example, following a progressive award triggering event, in addition to providing the progressive award to a user associated with winning the progressive award, the system employs one or more entries of the distributed ledger to provide one or more identified users associated with contributing to the progressive award a supplemental award of a portion of the progressive award, a portion of a supplemental award pool separately maintained by the system and/or a digital asset associated with digital content having one or more attributes or properties associated with the progressive award (e.g., a non-fungible token associated with the progressive award). It should be appreciated that since a progressive award may be contributed to by multiple (if not all) users of multiple gaming devices, such as multiple electronic gaming machines, but typically that progressive award is provided to a single user of a single gaming device, the configuration of this embodiment enables multiple users to receive benefits in association with such contributions. These benefits frequently mitigate any negative effects of not winning a progressive award and are often the difference between a user leaving a gaming device after a progressive award has been reset to a reset value (when the user is most likely to feel dejected and unwilling to contribute to the progressive award) and staying at the gaming device in hopes of winning the progressive award (or at least collecting another digital asset commemorative of their gaming experience).

In certain additional or alternative embodiments of employing one or more aspects of one or more distributed ledger databases to supplement or otherwise enhance one or more progressive awards, the system associates one or more tokens stored on a distributed ledger, such as one or more fungible tokens and/or non-fungible tokens, with such progressive awards. In certain such embodiments, the progressive award at least partially takes the form of the token such that as one or more aspects of the progressive award changes, the system causes changes to the token (e.g., a token includes digital content of a meter that increments as the progressive award grows in value) and/or causes supplemental tokens to be stored on the distributed ledger (e.g., a token includes digital content that, when combined with the digital content of one or more other tokens, results in a newly created token with relatively rare digital content). For example, in addition to any value (e.g., monetary value and/or cryptocurrency value) of a progressive award, the system associates the progressive award with a non-fungible token. In this example, as contributions to the progressive award occur, the system operates to create another non-fungible token derived from modifying one or more parameters of the initially created non-fungible token which results in a relatively more scarce (and thus relatively more valuable on a non-fungible token marketplace) non-fungible token associated with the incremented progressive award.

More specifically, in certain embodiments, in association with maintaining a progressive award, the system causes the creation of a token in a distributed ledger, such as a token written in a block on decentralized, open-source blockchain. In certain instances, the token is a non-fungible token having a unique cryptographic entry that is non-divisible, does not have a one-to-one value with other non-fungible tokens and is not interchangeable with other non-fungible tokens. In certain other instances, the token is a fungible token having a non-unique cryptographic entry that is one or more of: divisible, has a one-to-one value with other non-fungible tokens and is interchangeable with other non-fungible tokens. In different embodiments, the created token comprises one or more parameters or attributes determined based on (or alternatively independent of) the progressive award. For example, following a progressive award reset event, the system interfaces with one or more computing devices of a distributed ledger to cause the creation of a non-fungible token having one or more properties (e.g., traits or components of the digital content of the non-fungible token such as colors used and/or images displayed) associated with the progressive award. In this example, the attributes or properties of the non-fungible token are at least partially determined based on the reset value of the progressive award (e.g., the non-fungible token of the reset progressive award depicts a blank crown without any jewels).

In certain embodiments, in addition to or alternative from creating a token in association with a progressive award, the system monitors for an occurrence of a token modification event in association with maintaining the progressive award. In certain embodiments in which the token is a fungible token, upon an occurrence of a token modification event in association with maintaining the progressive award, the system operates with one or more computing devices associated with the distributed ledger to modify the fungible token and record such a modification. For example, following an amount of contributions to the progressive award reaching a threshold amount (i.e., an occurrence of a token modification event), the system causes the modification of the attributes or properties of the fungible token based on such contributions (e.g., the system modifies the digital content of the fungible token by adding a diamond to the crown). In certain embodiments in which the token is a non-fungible token, upon an occurrence of a token modification event in association with maintaining the progressive award, the system operates with one or more computing devices associated with the distributed ledger to cause the modification of one or more attributes or properties of an existing non-fungible token (e.g., updated traits to the digital content of the non-fungible token). For example, following an amount of contributions to the progressive award reaching a threshold amount (i.e., an occurrence of a token modification event), the system cause the modification of an attribute of the previously created non-fungible token based on such contributions (e.g., the system operates to create a non-fungible token depicting a diamond which is then combined with the existing non-fungible token depicting the blank crown to result in a semi-fungible token depicting a crown with a diamond). In certain embodiments in which the token is a non-fungible token, upon an occurrence of a token modification event in association with maintaining the progressive award, the system operates with one or more computing devices associated with the distributed ledger to create another non-fungible token based on the previously created non-fungible token and the occurrence of the token modification event. For example, following an amount of contributions to the progressive award reaching a threshold amount (i.e., an occurrence of a token modification event), the system creates another non-fungible token based on the attributes or properties of the previously created non-fungible token and the contributions to the progressive award (e.g., the system operates to create another non-fungible token that depicts a crown with a diamond). Such a configuration of utilizing tokens in association with one or more progressive awards enables certain users to accumulate such tokens as a collectable digital asset commemorating their gaming experience. Such a configuration further evidences how, in certain instances, modifications of one or more attributes or properties of a non-fungible token represent a benefit valued by certain users such that the more a user interacts with a gaming device, the more improved modifications to the attributes of an associated non-fungible token occur and the more lucrative that non-fungible token may become.

In certain additional or alternative embodiments of employing one or more aspects of one or more distributed ledger databases to supplement or otherwise enhance one or more awards, the system enables a user to fund part of an award associated with a distributed ledger with a digital currency, such as an amount of cryptocurrency stored in a cryptocurrency wallet of the user. In these embodiments, in exchange for a benefit, such as a fee, the user pledges their digital currency against an event occurring (or not occurring) in association with the award for a period of time. For example, the system enables a user to obtain an amount of funds (and/or a token of the distributed ledger) in exchange for pledging an amount of cryptocurrency to at least partially fund a progressive award for a set period of time. In such embodiments, if the event does not occur within the period of time (i.e., no pledged digital currency retention event occurred), the user retains ownership of the pledged digital currency and the benefit. For example, if no progressive award triggering event occurs within the set period of time, the pledge ceases such that the user retains the pledged amount of cryptocurrency as well as the amount of funds (and/or the token of the distributed ledger). On the other hand, if the event occurs within the period of time (i.e., a pledged digital currency retention event occurred), the system operates with one or more computing devices associated with the distributed ledger database to transfer ownership of the pledged digital currency to another party, such as the party that transferred the benefit to the user. For example, if a progressive award triggering event occurs within the set period of time, the user retain the amount of funds (and/or the token of the distributed ledger) but the system operates to transfer the pledged amount of cryptocurrency to the winner of the progressive award. Such a configuration enables a user to wager an amount of digital currency, such as an amount of cryptocurrency, in accordance with the system that maintains the award such that the user assumes a certain amount of risk (e.g., risk of losing the pledged digital currency via the event occurring) for the benefit realized.

While certain embodiments of the present disclosure are directed to employing a digital currency stored on a distributed ledger (e.g., an amount of cryptocurrency) to enhance one or more aspects of a progressive award, it should be appreciated that such embodiments may additionally or alternatively be employed in association with employing a digital currency stored on a distributed ledger (e.g., an amount of cryptocurrency) to enhance one or more aspects of one or more non-progressive awards, such as static valued awards. Similarly, while certain embodiments of the present disclosure are directed to creating and/or modifying tokens (e.g., fungible token and/or non-fungible tokens) stored on a distributed ledger in association with one or more progressive awards, it should be appreciated that such embodiments may additionally or alternatively be employed in association with creating and/or modifying tokens (e.g., fungible token and/or non-fungible tokens) stored on a distributed ledger in association with one or more non-progressive awards, such as static valued awards. It should be further appreciated that a gaming device employed in association with such progressive awards may be any suitable personal gaming device, such as a mobile device executing an application; any suitable electronic gaming machine (“EGM”) (such as a slot machine, a video poker machine, a video lottery terminal, a terminal associated with an electronic table game, a sporting event wagering terminal, a video keno machine, or a video bingo machine) which enables a user to play one or more games of chances, one or more games of skill (or partial skill), and/or place one or more sporting event wagers; any suitable slot machine interface board which is in communication with an EGM which enables a user to play one or more games of chances, one or more games of skill (or partial skill), and/or place one or more sporting event wagers; and/or any suitable combination of a server operating with a personal gaming device, an EGM, and/or a slot machine interface board associated with an EGM which enables a user to play one or more games of chances, one or more games of skill (or partial skill), and/or place one or more sporting event wagers.

In certain embodiments, the system maintains one or more progressive awards. In certain embodiments, the system maintains a single progressive award. In certain such embodiments, as described in more detail below, the progressive award is associated with a specific token associated with a distributed ledger, such as a specific non-fungible token. In certain embodiments, the progressive award is associated with a plurality of tokens associated with a distributed ledger, such as a plurality of non-fungible tokens. In certain embodiments, the progressive award is not initially associated with any tokens of a distributed ledger (and rather becomes associated with one or more tokens responsive to an occurrence of a token association event).

In certain embodiments, the progressive award is part of a plurality of progressive awards maintained in a multi-level progressive award configuration (“MLP”). In certain such embodiments, one or more of the progressive awards are each associated with a specific token associated with a distributed ledger, such as a specific non-fungible token. In certain embodiments, one or more of the progressive awards are each associated with a plurality of tokens associated with a distributed ledger, such as a plurality of non-fungible tokens. In certain embodiments, one or more of the progressive awards are not initially associated with any tokens of a distributed ledger (and rather become associated with one or more tokens responsive to an occurrence of a token association event). In different embodiments, the progressive award may be associated with a single gaming establishment (such that the progressive award may be considered a local area progressive (“LAP”)) or may be associated with two or more different gaming establishments (such that the progressive award may be considered a wide area progressive (“WAP”)).

In certain embodiments, the maintained progressive award is associated with a progressive award contribution rate that represents, in certain instances, the portion of each wager placed (or the portion of each designated wager, such as a maximum wager, placed) that is allocated to the progressive award. In certain embodiments wherein the system maintains a plurality of progressive awards, each of the progressive awards have the same progressive award contribution rate. In certain embodiments wherein the system maintains a plurality of progressive awards, two or more of the progressive awards have different progressive award contribution rates.

In certain embodiments, the maintained progressive award is associated with a starting value utilized when the progressive award becomes available to be won. In certain embodiments, the maintained progressive award is associated with a reset value utilized following a progressive award triggering event. In certain embodiments wherein the system maintains a plurality of progressive awards, each of the progressive awards have the same progressive award starting value and/or the same progressive award reset value. In certain embodiments wherein the system maintains a plurality of progressive awards, two or more of the progressive awards have different progressive award starting values and/or different progressive award reset values.

In certain embodiments, the maintained progressive award is associated with a range of values, wherein the low end of the range of values represents the starting value or reset value of the progressive award and the high end of the range of values represents the maximum amount which the progressive award may reach. In these embodiments, the amount which the progressive award may be incremented to is capped or limited by the highest value in the value range associated with such progressive award. In these embodiments, the system determines a progressive award hit value from the value range associated with the progressive award and displays the current value of the progressive award and/or the maximum amount which the progressive award may reach. In other embodiments, the progressive award is not associated with any range of values. In this embodiment, the progressive award continues to be incremented until a progressive award triggering event occurs.

In certain embodiments, one or more of the progressive award starting value and/or the progressive award reset value is a monetary value. In certain embodiments, one or more of the progressive award starting value and/or the progressive award reset value is a digital currency value, such as a cryptocurrency value. For example, the maintained progressive award is denominated in Bitcoin (“ [symbol] ”), Ether (“Ξ”), or another form of cryptocurrency. In certain such embodiments, based on the fluctuating value of certain cryptocurrencies, the system displays the amount of cryptocurrency and the equivalent monetary value (which is based on the current price of that cryptocurrency).

In certain embodiments, one or more of the progressive award starting value and/or the progressive award reset value is formed from multiple digital currencies (e.g., “1.05 [symbol] +10 Ξ). In certain embodiments, one or more of the progressive award starting value and/or the progressive award reset value is a monetary value and a digital currency value (e.g., $100,000+1 [symbol] or 1.05 [symbol] +10 Ξ+$2,300). In certain embodiments in which a plurality of progressive awards are maintained in an MLP configuration, different levels of the MLP configuration are associated with different types of progressive awards (e.g., level 1 of the MLP configuration is a monetary value win, level 2 of the MLP configuration is an Ξ win, level 3 of the MLP configuration is a [symbol] win, and level 4 of the MLP configuration is a non-fungible token win). In certain other embodiments in which a plurality of progressive awards are maintained in an MLP configuration, different levels of the MLP configuration are associated with different combinations of progressive awards (e.g., level 1 of the MLP configuration is a non-fungible token win, level 2 of the MLP configuration is the non-fungible token win plus an Ξ win, level 3 of the MLP configuration is the non-fungible token win plus a [symbol] win, and level 4 of the MLP configuration is the non-fungible token win plus a monetary value win). In certain such embodiments, based on the fluctuating value of certain cryptocurrencies, the system displays at least the cryptocurrency value using whole numbers ($3,600+4 [symbol] ).

In certain embodiments in which one or more of the progressive award starting value and/or the progressive award reset value is formed from multiple different cryptocurrencies, multiple different tokens (as described below), and potentially a monetary amount, the system displays each of the individual components that form the progressive award (e.g. the system displays a progressive award formed from five legendary non-fungible tokens, two epic non-fungible tokens and seven rare non-fungible tokens). In certain embodiments in which one or more of the progressive award starting value and/or the progressive award reset value is formed from multiple different cryptocurrencies, multiple different tokens (as described below), and potentially a monetary amount, the system displays an estimated value of the progressive award without displaying each of the individual components that form the progressive award.

In certain embodiments, in addition or alternative from having a monetary value and/or a digital currency value, the progressive award is associated with a token, such as a non-fungible token stored in association with a distributed ledger. In certain such embodiments, the token is associated with digital content representative of the token they can win. That is, the token is associated with one or more attributes or properties related to digital content displayable as a visual representation of the token. For example, the token is associated with a character having different attributes of eyes, a mouth, clothing, earrings and hat representative of certain attributes or properties of the token. In another example, the token is associated with one or more game elements memorializing one or more aspects of a current (or past) gaming session. In certain such embodiments, based on the fluctuating value of certain tokens, such as certain non-fungible tokens, the system displays the token and the equivalent monetary value (which is based on the current price of that token).

In certain embodiments, in associating a progressive award with a token, the system monitors for an occurrence of a token association event. In certain embodiments, the token association event occurs when the progressive award becomes available to be won. In certain embodiments, the token association event additionally or alternatively occurs following a progressive award triggering event. In certain embodiments, the token association event additionally or alternatively occurs based on (or as a result of) one or more displayed events occurring in association with one or more plays of one or more games. In another such embodiment, the token association event occurs independent of any displayed events associated with any plays of any games.

In certain embodiments, if the system determines that no token association event has occurred, the system continues with monitoring for an occurrence of a token association event. On the other hand, upon an occurrence of a token association event, the system associates a token, such as a non-fungible token and/or a fungible token, with one or more maintained progressive awards. In certain embodiments, such an association or linkage provides that one or more subsequent modifications to the progressive award, such as modifications to the value of the progressive award, result in zero, one or more modifications of the associated token in the distributed ledger. In certain embodiments, such an association or linkage additionally or alternatively provides that one or more subsequent modifications to the progressive award, such as modifications to the value of the progressive award, result in the creation of one or more tokens in the distributed ledger and a corresponding association of the created token(s) with the progressive award. In certain embodiments, such an association or linkage further provides that a subsequent triggering of the progressive award, such as a determination to provide any value of the progressive award to a user associated with a progressive award triggering event, results in a transfer of ownership of the associated token in the distributed ledger.

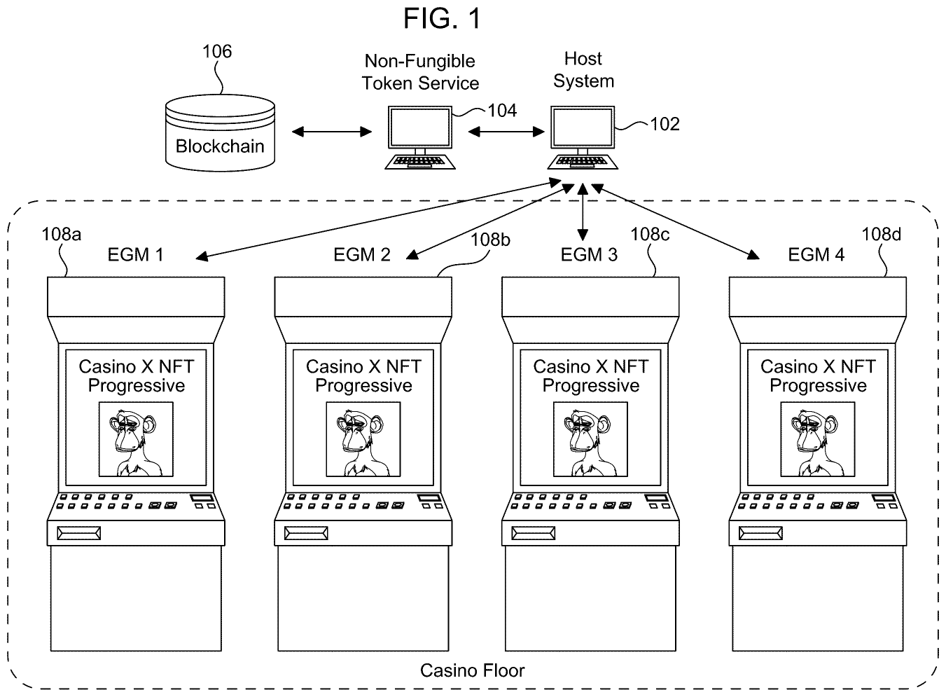

In certain embodiments, upon an occurrence of a token association event, the system enables a user (and/or an operator) to select a token to be associated with the progressive award. In certain embodiments, upon an occurrence of a token association event, the system enables a user (and/or an operator) to make one or more inputs to cause the association of a token with the progressive award. In certain embodiments, the system enables a user (and/or an operator) to make one or more inputs to cause a creation of a token to be associated with the progressive award. In such embodiments, following an occurrence of a token creation event, the system communicates a request for a token to a host system 102. The request includes part or all of any digital content associated with the token to be created. In certain embodiments, upon receiving and verifying the request for the creation of a token associated with any identified digital content, the host system communicates the request for the creation of a token associated with any identified digital content to an online token service 104 (e.g., an OpenSea system) which then operates to create a unique token in a distributed ledger 106 (e.g., creates a non-fungible token in a blockchain). In certain other embodiments, upon receiving and verifying the request for the creation of a token associated with the identified digital content, the host system operates to create a unique token in a distributed ledger independent of any online token service. As such, in certain embodiments, to create a token, the system communicates with a computing device associated with a distributed ledger to create a token in the distributed ledger while in certain other embodiments, to create a token, the system communicates with a token service to cause the creation of the token in the distributed ledger. In these different embodiments, following the creation of the token, the system associates the created token with the progressive award and causes zero, one or more gaming devices, such as electronic gaming machines 108 of FIG. 1, to display the created token associated with the progressive award.

In various embodiments, to facilitate the association or linkage of a token with a progressive award, the system determines whether or not to complete the attempted association. In these embodiments, upon receiving data or information regarding a token, the system interfaces with, such as via one or more application programming interfaces, one or more computing devices associated with a distributed ledger, such as nodes of an external non-fungible token blockchain network (e.g., an ethereum blockchain network) associated with the token to determine whether or not to associate a token with the progressive award. In certain embodiments, to facilitate the transferring of data between one or more computing devices associated with the distributed ledger and a token wallet, the token wallet creates and registers (as necessary) the respective token account with the corresponding distributed ledger. Upon receiving the request, one or more computing devices associated with a distributed ledger and/or the system determine whether to authorize the association of the token with the progressive award. If the one or more computing devices associated with a distributed ledger and/or the system determines to authorize the association of the token with the progressive award, the system associates the identified token with the progressive award. In these embodiments, a gaming device (and/or another interface) displays one or more messages regarding the association of the token with the progressive award. On the other hand, if the one or more computing devices associated with a distributed ledger and/or the system determines not to authorize the association of the token with the progressive award, the system rejects the association of the identified token with the progressive award. In these embodiments, the gaming device (and/or another interface) displays one or more denial messages.

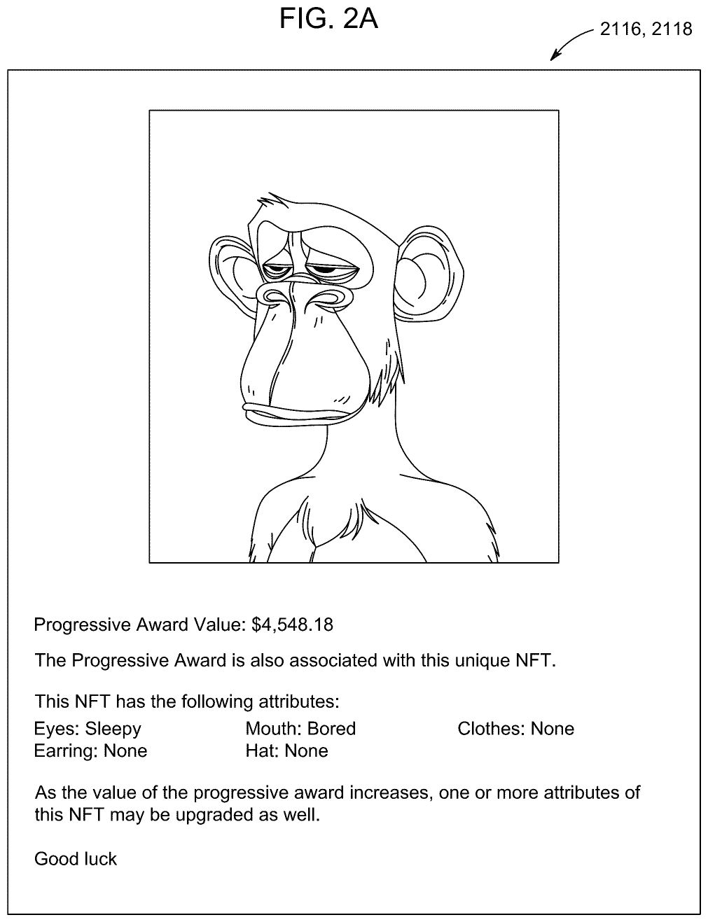

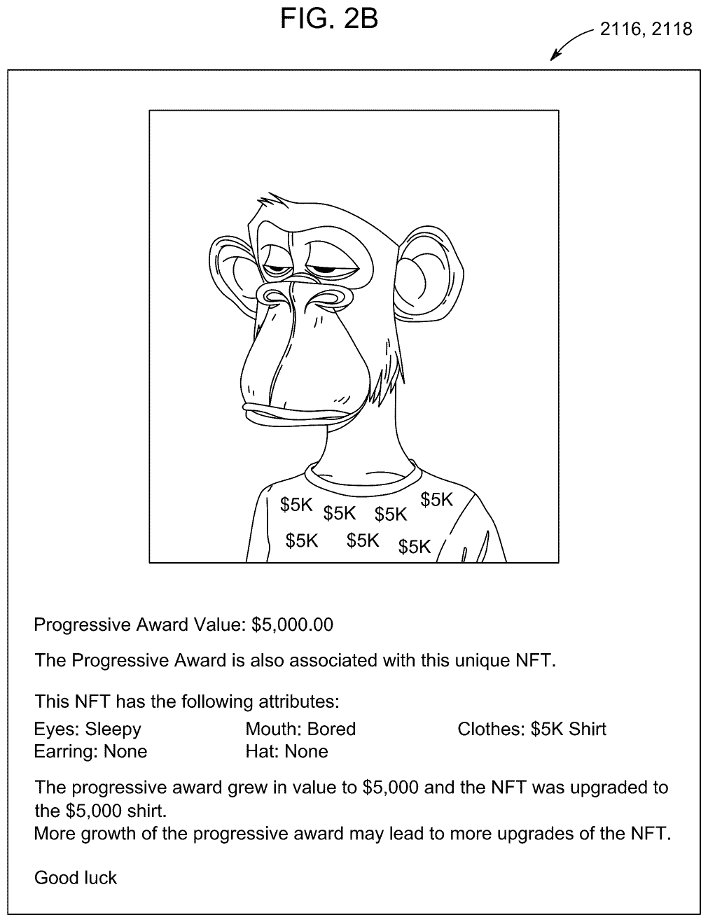

In certain embodiments, as part of or following any association or linkage of any tokens with the maintained progressive award, the system determines one or more attributes or properties of the associated token. In certain such embodiments, if the attributes of the associated token relate to digital content, the system causes a gaming device (or other display device) to display such digital content. Such digital content includes, but is not limited to, digital content associated with the progressive award, digital content generated in association with a prior gaming experience, digital content generated in association with a prior non-gaming experience, and/or user generated digital content (e.g., digital content generated by the user and/or content saved in association with the user's gaming establishment account) which individually or collectively form a representation of the token. In these embodiments, since, as described below, one or more events occurring in association with the progressive award results in modifications to one or more attributes or properties of an existing associated token, the system causes a gaming device to display the current attributes or properties of the token (certain of which collectively form the digital content of the token associated with the progressive award). For example, as seen in FIG. 2A, following the association of a progressive award with a non-fungible token, the gaming device displays a visual representation of a created non-fungible token. In this example, the eyes, mouth, clothing, earrings and hat represent certain of the attributes or properties of the non-fungible token which, as described below, may be modified responsive to one or more events occurring in association with the progressive award.

In certain embodiments, zero, one or more attributes or properties of the token associated with the progressive award relate to feature data which can be used in association with a play of a game. In different embodiments, the feature data relates to any suitable feature which modifies any aspect of any game played by the user, including, but are not limited to: a feature modifying one or more symbols available to be generated for a play of a game; a feature modifying one or more wild symbols available to be generated for a play of a game; a feature modifying a quantity of reels to be used for a play of a game; a feature modifying which of a plurality of reel are to be used for a play of a game; a feature modifying a deck of playing cards to be used for a play of a game; a feature modifying a quantity of playing cards to be used for a play of a game; a feature modifying a quantity of poker hands to be dealt for a play of a game; a book-end wild symbols feature; a stacked wild symbols feature; an expanding wild symbols feature; a retrigger symbol feature; an anti-terminator symbol feature; a locking reel feature, a locking symbol position feature; a modifier, such as a multiplier, feature; a feature modifying an amount of credits of a credit balance; a feature modifying an amount of promotional credits; a feature modifying a placed wager amount (e.g., a player placed a bet of $1 which is treated by the EGM as a bet of $2); a feature modifying a placed side wager amount; a feature modifying a rate of earning player tracking points; a feature modifying a rate of earning promotional credits; a feature modifying a rate of earning virtual credits; a feature modifying a number of wagered on paylines; a feature modifying a wager placed on one or more paylines (or on one or more designated paylines); a feature modifying a number of ways to win wagered on; a feature modifying a wager placed on one or more ways to win (or on one or more designated ways to win); a feature modifying an average expected payback percentage of a play of a game; a feature modifying an average expected payout of a play of a game; a feature modifying one or more awards available; a feature modifying a range of awards available; a feature modifying a type of awards available; a feature modifying one or more modifiers, such as multipliers, available; a feature modifying an activation of a reel (or a designated reel); a feature modifying an activation of a plurality of reels; a feature modifying a generated outcome (or a designated generated outcome); a feature modifying a generated outcome (or a designated generated outcome) associated with an award over a designated value; a feature modifying a generated outcome (or a designated generated outcome) on a designated payline; a feature modifying a generated outcome (or a designated generated outcome) in a scatter configuration; a feature modifying a winning way to win (or a designated winning way to win); a feature modifying a designated symbol or symbol combination; a feature modifying a generation of a designated symbol or symbol combination on a designated payline; a feature modifying a generation of a designated symbol or symbol combination in a scatter configuration; a feature modifying a triggering event of a play of a secondary or bonus game; a feature modifying an activation of a secondary or bonus display (such as an award generator); a feature modifying a quantity of activations of a secondary or bonus display (e.g., a feature modifying a quantity of spins of an award generator); a feature modifying a quantity of sections of a secondary or bonus display (e.g., a feature modifying a quantity of sections of an award generator); a feature modifying one or more awards of a secondary or bonus display; a feature modifying an activation of a community award generator; a feature modifying a quantity of activations of a community award generator; a feature modifying a quantity of sections of a community award generator; a feature modifying one or more awards of a community award generator; a feature modifying a generated outcome (or a designated generated outcome) in a secondary game; a feature modifying a quantity of picks in a selection game (e.g., provide a player four picks in a selection game otherwise associated with 3 picks); a feature modifying a quantity of offers in an offer and acceptance game; a feature modifying a quantity of moves in a trail game; a feature modifying an amount of free spins provided; a feature modifying a game terminating or ending condition; a feature modifying an availability of a secondary game; a feature modifying a theme of a game; and/or a feature modifying any game play feature associated with any play of any game of the present disclosure.

It should be appreciated that since different tokens are associated with different combinations of attributes and different attributes have different scarcities, the combination of attributes of a token and the scarcity of each respective attribute at least partially dictate the value associated with the token. That is, at least the scarcity of the individual attributes of the token (which is provided by the blockchain technology in the form of how many/a percentage of tokens share the same individual attribute), the reputation of the author/issuer of the token as well as the liquidity of the token (e.g., are there buyers/sellers of the token and/or the individual attributes of the token) drive the marketplace value of the token. For example, if a limited amount of content utilized as non-fungible token art is provided by a third-party (e.g., an influencer or celebrity) to be used with non-fungible tokens created and/or modified by the system of the present disclosure, then based on the scarcity of that content, a non-fungible token associated with such content may have a higher value than a non-fungible token not associated with such content. In such an example, the supply of the token in a token marketplace at a given point in time relative to the demand of the token in the token marketplace at that point in time determines the value of the token.

In certain embodiments, the token includes one or more digital content components in one or more media formats. In such embodiments, the digital content components includes one or more of: still images (e.g., a screen capture of an outcome of a play of a game), video clips (e.g., a video recording of a play of a game or a video clip the user previously uploaded), sound clips (e.g., a user's verbal reaction to a play of a game), audio-video clips, text (e.g., a meme the user previously uploaded), social media site information (e.g. a uniform resource locator of a social media site), transaction information (e.g., a wager amount), location information, application usage information, token service information and statistics, and/or biometric information. In certain embodiments, the digital content components are combinable with contextual information, such as information about a person, place and time, and then formatted to assist in the creation of the token. In certain embodiments, the system enables the user (and/or the system operator) to select one or more characteristics or parameters of the token they prefer, such as the type of information associated with the token. In certain such embodiments, a user's selection of one or more characteristics or parameters of the token factors into one or more challenges the token subsequently participates in (e.g., the user selects the characteristics of a non-fungible token associated with digital content of a tank and the results of a subsequent challenge involving that non-fungible token are at least partially based on which characteristics selected (or not-selected)).

In certain embodiments, in addition to maintaining a progressive award potentially denominated at least partially with an amount of cryptocurrency and/or potentially associated with a token of a distributed ledger, the system determines if a progressive award increment event has occurred in association with one or more of the maintained progressive awards. In one such embodiment, the progressive award increment event occurs based on (or as a result of) a wager being placed on a play of a game at an EGM associated with that award. In another such embodiment, the progressive award increment event additionally or alternatively occurs based on (or as a result of) a side wager being placed at an EGM associated with that award. In another such embodiment, the progressive award increment event additionally or alternatively occurs based on (or as a result of) one or more displayed events occurring in association with one or more plays of one or more games. In another such embodiment, the progressive award increment event occurs independent of any displayed events associated with any plays of any games. For example, a gaming establishment may periodically cause an occurrence of a progressive award increment event with funds drawn from the gaming establishment marketing department.

In certain embodiments, if the system determines that a progressive award increment event occurred in association with a progressive award, the system increases a current value of that maintained progressive award. In certain embodiments wherein the progressive award increment event occurs based on a placed wager, the increase of the maintained award is funded by a portion of the wager placed (e.g., a progressive award contribution rate of 1% of the amount of the wager placed is allocated to growing the progressive award). In certain other embodiments wherein the progressive award increment event occurs based on a placed side wager, the increase of the maintained award is funded by part or all of the side wager placed (e.g., a progressive award contribution rate of 50% of the amount of the side wager placed is allocated to growing the progressive award). In certain embodiments in which the progressive award is formed from a fiat currency and one or more digital currencies, the currency of the contribution to the progressive award determines the currency growth of the progressive award. For example, if a progressive award increment event occurs in association with a wager of a dollar, the system increases the monetary currency portion of the progressive award. In this example, if the progressive award increment event occurs in association with a wager of [symbol] , the system increases the [symbol] portion of the progressive award. In certain other embodiments, the system utilizes an amount provided by one or more marketing and/or advertising departments, such as a gaming establishment marketing department, to fund part or all of the increase of the maintained award upon an occurrence of a progressive award increment event.

In certain embodiment, the system employs a distributed ledger to track contributions to the progressive award. In certain such embodiments, the system tracks contributions to the progressive award of an individual user identified via a patron management system (e.g., a player tracking account associated with a user). In these embodiments, the system enables the user to log into the patron management system from the gaming device. Upon a progressive award increment event occurring in association with the identified user, the system operates with one or more computing devices of a distributed ledger to record the contribution to the progressive award attributed to the user. In certain of these embodiments, a user at a gaming device utilizes a mobile device application associated with the patron management system running on a mobile device and/or a physical instrument (e.g., a smart card or a user issued magnetic striped card associated with an identity of the user that the user utilizes via inserting the card into a card reader associated with the gaming device) to identify themselves to the gaming device to enable contributions to the progressive award associated with the user to be recorded in the distributed ledger.

In certain embodiments in which the progressive award is associated with a token, such as a fungible token and/or a non-fungible token, if the system determines that a progressive award increment event occurred in association with a progressive award, the system modifies the token associated with the progressive award. In such embodiments, certain occurrences of the progressive award increment event comprise an occurrence of a modification event of the token associated with the progressive award. That is, certain increases of the progressive award are associated with (or otherwise take the form of) a modification of the token associated with the progressive award.

In certain embodiments in which the token associated with the progressive award is a fungible token, certain occurrences of the progressive award increment event result in the system modifying the fungible token. In these embodiments, the system operates with one or more computing devices associated with the distributed ledger to modify the fungible token and record such a modification.

In certain embodiments in which the token associated with the progressive award is a non-fungible token, certain occurrences of the progressive award increment event result in the system modifying the non-fungible token associated with the progressive award. In these embodiments, the system operates with one or more computing devices associated with the distributed ledger to create another non-fungible token based on the previously created non-fungible token and the occurrence of the progressive award increment event. In these embodiments, the system operates to associate the newly created non-fungible token with the progressive award and disassociate the previously created non-fungible token from being associated with the progressive award.

In certain embodiments in which the token associated with the progressive award is a non-fungible token, certain occurrences of the progressive award increment event result in the system modifying the non-fungible token associated with the progressive award. In these embodiments, the system operates with one or more computing devices associated with the distributed ledger to create another non-fungible token based on the occurrence of the progressive award increment event and then combine the existing non-fungible token with the created non-fungible token to result in a newly formed non-fungible token. For example, the system associates a non-fungible token with a progressive award in which the non-fungible token includes digital content representative of a blank crown without diamonds. In this example, following an occurrence of a progressive award increment event, the system creates another non-fungible token including digital content representative of a diamond and combines the two non-fungible tokens to result in a relatively more valuable non-fungible token including digital content representative of a crown with a diamond. In another example, the system associates a threshold amount of funds with a non-fungible token including digital content representative of crown and further associates lower threshold amounts of funds with different non-fungible tokens including digital content representative of diamonds. In this example, as progressive award increment events occur and the amount of the progressive award increases, the system incrementally combines the non-fungible tokens to create additional non-fungible tokens such that if the progressive award reaches the threshold amount of funds, the created non-fungible token would include a digital content representative of the crown and each of the diamonds. In certain embodiments, the system enables the user (and/or an operator) to make one or more inputs regarding one or more attributes of the created non-fungible token (which is then combined with the existing non-fungible token to result in a newly formed non-fungible token) and/or the combination of the created non-fungible token and the existing non-fungible token.

It should be appreciated that such a combination of attributes from multiple non-fungible tokens operates, in certain instances, as a semi-fungible token representative of a combination of multiple unique non-fungible tokens. In such embodiments, the system operates to associate the newly formed token with the progressive award and disassociate the previously created token from being associated with the progressive award. As such, depending on the configuration of the host system, the token service and/or the distributed ledger (e.g., the blockchain), the modification of one or more attributes of a token may include updating the data associated with that token to reflect the modified attribute or retiring a non-fungible token and replacing the retired non-fungible token with a new non-fungible token that retains certain unmodified attributes and the modified attributes. In certain embodiments, once combined from multiple non-fungible tokens, the resulting token remains a unique property and individually owned by a single party. In certain embodiments, the system enables a user to divide such a created token back into the multiple non-fungible tokens combined to form the resulting token.

In various embodiments, the modification of the token associated with the progressive award and/or the replacing of a token associated with the progressive award with another token includes a modification of the digital content of the associated token with additional or alternative digital content. In these embodiments, the existing attributes or properties of the token are modified with or otherwise replaced with one or more created attributes or properties of one or more of these different sources of digital content to collectively form a modified fungible token or a new non-fungible token based on certain attributes of a disassociated non-fungible token. As such, if a token is associated with a progressive award and one or more events occur in association with the progressive award, such as a growth of the progressive award to a threshold level, the system modifies the token, such as by creating one or more token attributes or properties and utilizing those created token attributes or properties to replace one or more of attributes or properties of the existing token. For example, as seen in FIG. 2B, upon determining that the progressive award has reached a threshold level of $5,000 (which qualifies as a token modification event), the system causes a modification of the existing token by modifying the clothing attribute of the token from no clothing to a shirt associated with a $5,000 threshold.

In certain embodiments, following an occurrence of a progressive award increment event that qualifies as a token modification event, the system communicates a request for a modification of the associated token to a host system. The request includes part or all of the digital content associated with the token to be modified and/or replaced with a new token. In certain such embodiments, the request includes one or more created token attributes or properties communicated to the host system for the host system to employ in modifying and/or replacing the associated token. In certain embodiments, upon receiving and verifying the request for the modification and/or replacement of a token associated with the identified digital content, the host system communicates the request to an online token service (e.g., an OpenSea system) which then operates to modify, in a distributed ledger, the unique token associated with the progressive award (or operates to create, in the distributed ledger, a new unique token to associated with the progressive award). In certain other embodiments, upon receiving and verifying the request, the host system operates to modify, in the distributed ledger independent of any online token service, the unique non-fungible token associated with the progressive award (or operates to create, in the distributed ledger, a new unique token to associated with the progressive award).

It should be further appreciated that one or more tokens of the present disclosure may be implemented in accordance with any suitable distributed ledger technology. Such distributed ledger technology which the tokens of the present disclosure may be associated with includes any suitable distributed ledger that enables recording and sharing of information across multiple data stores wherein each of the data stores (i.e., ledgers) includes the same data records, subject to maintenance and control through a distributed network of computing nodes. In different embodiments, such distributed ledger technology includes, but is not limited to, blockchain, directed acyclic graph, hashgraph, holochain, tempo (Radix), and any variation of these distributed ledger technologies in permissioned and/or permissionless form.

In certain embodiments wherein the employed distributed ledger technology utilizes blockchain technology, one or more non-fungible tokens are implemented in a blockchain, such as Ethereum. In these embodiments, the non-fungible token is either stored directly in the blockchain (e.g., using a smart contract that follows the ERC-721 standard) or a reference to the non-fungible token (e.g., a URL to the non-fungible token) is stored in the blockchain. In certain embodiments, various information associated with the created non-fungible token and/or the progressive award is indicated in the blockchain. In certain such embodiments, the information stored in the blockchain includes the owner of the non-fungible token, a URL associated with the non-fungible token, a history of the non-fungible token, the digital content associated with the non-fungible token, data associated with the non-fungible token (e.g., the date and time of an event the non-fungible token represents) and/or data associated with progressive award. In other such embodiments, the information stored in the blockchain additionally (or alternatively) includes a state of the non-fungible token. In one such embodiment, the state of the non-fungible token relates to a redemption state wherein when the non-fungible token is first created, the non-fungible token is not redeemed, but later the state changes to redeemed after the owner of the non-fungible token invokes a behavior associated with the non-fungible token.

In certain embodiments wherein the employed distributed ledger technology differs from blockchain technology, one or more non-fungible tokens are implemented in accordance with a directed acyclic graph protocol (which provides potentially higher throughput of transactions, and fee-less transactions). In these embodiments, the directed acyclic graph protocol enables the storing of the non-fungible token or a reference to the non-fungible token but without the utilization of blocks. Specifically, the directed acyclic graph of this embodiment employs a finite directed graph that includes an infinite amount of edges and vertices, wherein each edge is directed from one vertex to another without having to start at any one particular vertex or follow a consistent or directed sequence of edges to loop back to the same vertex again.

In addition to increasing the progressive award (if the progressive award increment event occurs) or maintaining the progressive award (if no progressive award increment event occurs), the system determines if a progressive award triggering event has occurred. In these embodiments, in addition to periodically growing the value of one or more progressive awards (and modifying, if applicable, one or more associated tokens stored in a distributed ledger), the system determines whether any event occurred (or any event failed to occur) that resulted in the availability of the progressive award (and any associated token) for a user.

In certain embodiments, a progressive award triggering event occurs based on one or more displayed events associated with one or more plays of one or more games. In certain embodiments in which the progressive award triggering event occurs in association with a play of a game, the game includes a play of a primary game, such as a primary wagering game, or a play of a secondary game, such as a free spin game. In certain embodiments, the play of the game is implemented as a game of chance (and/or a game of skill) in a networked environment, such as over the internet, in which the system enables a plurality of users, such as players, to each participate simultaneously in plays of the game using their own personal electronic device. For example, the system enables a plurality of players to access those systems via one or more web browsers running on one or more personal gaming devices to access plays of games via an online casino which employs monetary currency. In certain embodiments, the play of the game is implemented as a casual or social game of chance (and/or a casual or social game of skill) playable via social networks or online casinos in a networked environment which employ virtual currency in the form of virtual points or credits which may not be redeemed for any monetary value (contrasted with land-based casinos which employ credits redeemable for monetary currency). In certain such embodiments, the causal or social game requires the player to place a virtual currency wager to activate the casual or social game. In certain other embodiments, the play of the game is implemented as a game of chance (and/or a game of skill) playable in a gaming environment, such as a play of an EGM at a land-based casino, which employs currency in the form of monetary credits (which can be redeemed for monetary value). In certain such embodiments, the game of chance (and/or game of skill) requires the player to place a monetary wager to activate the game of chance. Such games of chance include any suitable game including, but not limited to: a play of any suitable slot game; a play of any suitable wheel game; a play of any suitable table game (whether played at a gaming table or from a gaming device remote from the gaming table) including, but not limited to: a play of any suitable card game, such as but not limited to any suitable poker game (including, but not limited to, Texas Hold'em, Omaha, Three Card Poker, Four Card Poker, Seven Card Stud, Pai Gow Poker, Caribbean Stud Poker, Let It Ride Poker), any suitable blackjack game, any suitable Baccarat game, any suitable Spanish 21 game, any suitable Casino War game, any suitable Super Fun 21 game, and any suitable Vegas Three Card Rummy game, a play of any suitable craps game, and/or a play of any suitable roulette game; a play of any suitable offer and acceptance game; a play of any suitable award ladder game; a play of any suitable puzzle-type game; a play of any suitable persistence game; a play of any suitable selection game; a play of any suitable cascading symbols game; a play of any suitable ways to win game; a play of any suitable scatter pay game; a play of any suitable coin-pusher game; a play of any suitable elimination game; a play of any suitable trail game; a play of any suitable bingo game; a play of any suitable video scratch-off game; a play of any suitable pick-until-complete game; a play of any suitable shooting simulation game; a play of any suitable racing game; a play of any suitable promotional game; a play of any suitable high-low game; a play of any suitable lottery game; a play of any suitable number selection game; a play of any suitable dice game; a play of any suitable auction game; a play of any suitable reverse-auction game; a play of any suitable group game; and/or a play of any suitable game of the present disclosure.

It should be appreciated that when the game is implemented as a game of skill, the system enables a user to make one or more quantifiable skill inputs to manipulate, influence or otherwise control one or more aspects of the game of skill (and thus influence or otherwise affect the outcome of the game of skill). In these embodiments, a user's skill is determined and quantified by one or more inputs (or the lack of any inputs) by the user that tend to measure one or more aspects of the user's skill. For example, skill includes utilizing one or more skill input devices to exhibit: (i) physical skill, such as, but not limited to: timing, aim, physical strength or any combination thereof which is quantifiable by zero, one or more inputs made by the user in association with the game of skill; (ii) mental skill (i.e., knowledge, reasoning, and/or strategy) which is quantifiable by one or more inputs made by the user (or the lack of any inputs made by the user) in association with the game of skill; and (iii) any other type of skill which is quantifiable by one or more inputs made by the user (or the lack of any inputs made by the user) in association with the game of skill. Such skill input devices include, but are not limited to: joysticks, buttons, a mouse or a plurality of mice, one or more trackballs, one or more pointing devices, a personal gaming device, such as a mobile device, one or more bodily motion trackers such as motion sensing devices for human-computer interaction, touchpads, touchscreens, one or more controllers with: (1) one or more motion sensing devices, (2) one or more proximity sensing devices, (3) one or more force sensing devices (transducers), (4) one or more accelerometers, or any other suitable skill input devices.

In certain embodiments, a progressive award triggering event occurs independent of any displayed events associated with any plays of any games. In these embodiments, the progressive award triggering event may occur in association with any aspect of the user's interaction with the gaming device, such as, not limited to, any aspect of the user's non-gaming experience at a gaming establishment, and/or any aspect of the user's non-gaming experience remote from a gaming establishment. That is, the progressive award triggering event may occur independent of any aspect of any game of chance, any game of skill, any lottery game or any sporting event wagering activity.

In certain embodiments, a progressive award triggering event occurs in association with one or more tracked events (such as one or more events tracked by a patron management system and stored by the patron management system or stored in association with the non-fungible token). In these embodiments, upon one or more tracked events occurring in association with a tracked user (such as a tracked identified user or a tracked anonymous user), the system causes a progressive award triggering event to occur. For example, when a patron management system determines that, based on a user's spend at a gaming establishment, the user has transitioned from one status level to a higher status level, in recognition of the achievement, the patron management system causes a progressive award triggering event to occur.

In certain embodiments, the progressive award triggering event occurs based on any event or series of events associated with the user's non-gaming experience. In these embodiments, a progressive award triggering event occurs in association with an achievement reached by the user, such as completing certain non-gaming activities associated with one or more gaming establishments. In different embodiments, such progressive award triggering events include, but are not limited to: a redemption of a quantity of player tracking points, a user making one or more purchases at one or more retail locations of a gaming establishment, a user making one or more designated purchases at one or more retail locations of a gaming establishment, a user attending one or more events at a gaming establishment, a user utilizing one or more gaming establishment services, a user attending a club and/or show associated with a gaming establishment, a user taking a picture associated with the gaming establishment, a user observing one or more other people, and/or a user observing the activity of other people.

In certain embodiments, upon an occurrence of a progressive award triggering event associated with a maintained progressive award, the system causes that maintained award to be made available to a user. In certain such embodiments in which the progressive award is associated with a monetary value, the system causes the monetary value to be made available to the user, such as by being credited to a credit meter of a gaming machine, transferred to a gaming establishment account associated with the user or associated with a cashless ticket voucher distributed to the user.

In certain embodiment in which the system employs a distributed ledger to track contributions to the progressive award, upon an occurrence of a progressive award triggering event, the system utilizes the recorded contributions to make one or more supplemental awards available to one or more users based on such contributions to the progressive award. In these embodiment, when a progressive award triggering event occurs, the system determines, based on the entries recorded to the distributed ledger, which users contributed to the progressive award and causes such users to be provided a supplemental award. In certain such embodiments, the supplemental award includes a monetary value, such as an amount funded from the progressive award or a supplemental pool employed to fund supplemental awards. In certain additional or alternative embodiments, the supplemental award is a token, such as a fungible token or a non-fungible token, associated with the distributed ledger. In certain embodiments, the supplemental awards are the same for each user such that any contribution to the progressive award which is recorded, in the distributed ledger, in association with an individual user, enables that user to win the supplemental award. In certain embodiments, the supplemental awards are different for different users based on the amount contributed to the progressive award (and/or a status of the user) such that different contribution amounts to the progressive award that are recorded, in the distributed ledger, in association with different users, enable such users to win different supplemental awards. It should be appreciated that the supplemental award may be any suitable award (e.g., a monetary award, a cryptocurrency award, an amount of player tracking points) and/or feature operable to modify one or more aspects of a play of a game.

In certain embodiments in which the progressive award is additionally or alternatively associated with one or more entries of a distributed ledger (e.g., an amount of digital currency and/or a token), the progressive award triggering event results in a distribution of a distributed ledger award. In certain of these embodiments, an occurrence of a progressive award triggering event automatically triggers a distribution event associated with the one or more entries of the distributed ledger (e.g., an amount of digital currency and/or a token). In certain embodiments in which the system maintains one or more progressive awards associated with at least one or more digital currencies and/or one or more tokens, upon an occurrence of a progressive award triggering event, the system enables the user to select the type of progressive award to receive.

In certain embodiments, a distribution occurs based on an occurrence of an additional event independent of a progressive award triggering event. In certain such embodiments in which a token is associated with a progressive award, if the system determines that a token distribution event did not occur based on the occurrence of the progressive award triggering event, the system continues to periodically monitor for an occurrence of a token distribution event. In other words, while, in certain embodiments, ownership of a token associated with a won progressive award may temporarily remain, in the distributed ledger, with the host system, in an effort to transfer ownership, in the distributed ledger, from the host system to a token wallet associated with a user, the system periodically redetermines whether a token distribution event occurs. On the other hand, if the system determines that a token distribution event occurred in association with the progressive award triggering event, the system causes a transfer of the token in the distributed ledger. That is, upon an occurrence of a token distribution event with the winning of a progressive award, the host system operates with one or more computing devices associated with the distributed ledger to transfer the token associated with the progressive award from being owned, in the distributed ledger, by the host system to being owned, in the distributed ledger, by a token wallet associated with a winner of the progressive award.

It should be appreciated that in certain embodiments the system employs distributed ledger technology to manage the ownership of the tokens associated with the progressive award. Specifically, the token associated with the progressive award is built upon public-key cryptography that utilizes pairs of keys: public keys (which are publicly known and essential for identification) and private keys (which are kept secret and are used for authentication and encryption). In operation, upon the creation of a token associated with a progressive award, a private key of the host system is used to assign the created token to an address associated with the host system. Put differently, the owner of the token (or other distributed ledger asset) possess a private key, wherein by using the key to encrypt or decrypt certain information, third-parties can verify that the correct private key was used and therefore the entity encrypting with the private key is the valid owner. Accordingly, via the use of a public key to verify information was signed with the matching private key, any party can verify that the host system is the owner of the token and thus has the authority to transfer the token upon an occurrence of a token distribution event.

In certain embodiments, upon an occurrence a token distribution event, the system utilizes one or more components of a gaming establishment token management system to transfer, in the distributed ledger, the token associated with the progressive award to an address associated with a user that won the progressive award. In these embodiments, the system includes (or is otherwise associated with) a gaming establishment token management system that maintains a gaming establishment token management account associated with a token wallet. The token wallet contains one or more token keys of the user that won the progressive award wherein to facilitate an ownership transfer of the token, the system transfers the token from being owned by a key associated with the host system to a key associated with the user that is held in a token wallet associated with the gaming establishment token management system account maintained for the user. In certain other embodiments wherein a created and/or modified token associated with the progressive award is associated with a key of the host system, the system requires the user to validate their identity online with the host system. In certain instances, this validation could include the user logging into a gaming establishment mobile application (or a gaming establishment website) and correctly entering information associated with an account (e.g., correctly entering an assigned user identification, a personal identification number, an email address, and/or a password) and/or validating that they own an associated email address and/or mobile phone number. In these embodiments, once the user's identity has been validated, the user could then enter a wallet address on the distributed ledger to transfer the token to.

In certain embodiments, upon an occurrence a token distribution event, the system utilizes one or more components of a patron management system to transfer, in the distributed ledger, the created and/or modified token associated with the progressive award to an address associated with the user that won the progressive award. In these embodiments, the system includes (or is otherwise associated with) a patron management system that maintains a patron management account, such as a player tracking account, associated with a token wallet. The token wallet contains one or more token keys of the user wherein following the host system creating or modifying (or causing the creation or modification of) a token, the system transfers the token from being owned by a key associated with the host system to a key associated with the user that is held in a token wallet associated with the patron management system account maintained for the user. For example, following the establishment of a wireless connection between a gaming device and a mobile device application associated with a player tracking account, the user utilizes the mobile device application to inform the player tracking system of the token wallet address to transfer the token to. In another example, following the establishment of a wireless connection between a gaming device and a mobile device application associated with a player tracking account, the gaming device communicates data to the mobile device which takes the user to a token website (or launches a token mobile device application) where the user enters their token wallet address and information to transfer the token to the user's ownership.

In certain embodiments, upon an occurrence a token distribution event, the system utilizes one or more machine-readable codes to facilitate the transfer, in the distributed ledger, of the created and/or modified token associated with the progressive award to an address associated with the user that won the progressive award. In these embodiments, once a user's identity has been validated (via the use of a mobile device application and/or a physical instrument, such as a player tracking card, associated with the user), the host system utilizes one or more machine readable codes, such as a QR code, as the token delivery mechanism. For example, a gaming device displays a QR code that, when scanned by the user using a mobile device, takes the user to a token website (or launches a token mobile device application and/or a gaming establishment mobile device application) where the user enters their token wallet address and information to transfer the token to the user's ownership. In another example, the gaming device produces a ticket that, when scanned by a user using a mobile device or kiosk, takes the user to a token website (or launches a token mobile device application and/or a gaming establishment mobile device application) where the user enters their token wallet address and information to transfer the token to the user's ownership.

In certain embodiments in which the distributed ledger award is an amount of cryptocurrency associated with a progressive award, if the system determines that the progressive award triggering event did not occur, the system continues to periodically monitor for an occurrence of a progressive award triggering event. On the other hand, if the system determines that a progressive award triggering event occurred, the system causes a transfer of the an amount of cryptocurrency in the distributed ledger. That is, upon an occurrence of a progressive award triggering, the host system operates with one or more computing devices associated with the distributed ledger to transfer the an amount of cryptocurrency associated with the progressive award from being owned, in the distributed ledger, by the host system to being owned, in the distributed ledger, by a crypto wallet associated with the user. Such transfers of an amount of cryptocurrency employ public and private keys as described above in relation to the transfer of a token associated with a progressive award from being owned, in the distributed ledger, by the host system to being owned, in the distributed ledger, by a wallet associated with the user.

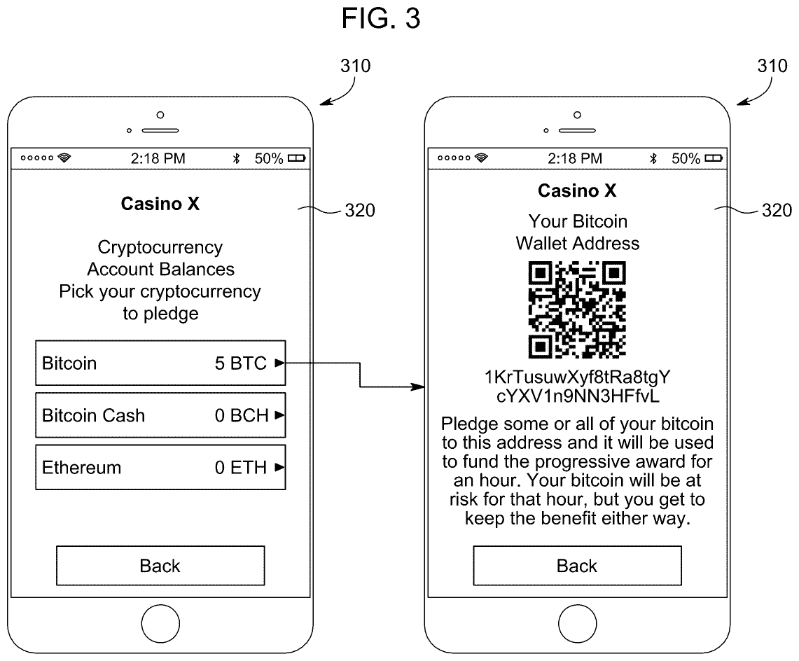

In certain additional or alternative embodiments that employ an amount of cryptocurrency in association with a progressive award, the system enables a user to contribute, for a limited duration, an amount of cryptocurrency in exchange for a benefit. In certain embodiments, the user's contribution is associated with an event occurring (or not occurring) within the limited duration. For example, the user pledges an amount of cryptocurrency that an event will (or will not occur) within a limited duration in which the determination of whether or not the user retains the pledged amount of cryptocurrency is based on whether or not the event occurred (or did not occur). In certain embodiments, the user contributed amount of cryptocurrency funds, for the limited duration, at least part of the progressive award. For example, as seen in the sequence of messages displayed via a mobile device application 320 of a mobile device 310 of FIG. 3, upon a determination that a user associated with an amount of cryptocurrency wants to risk their amount of cryptocurrency for a benefit (i.e., an occurrence of a contribution eligibility event), the system enables the user to pledge an amount of cryptocurrency to seed part or all of a progressive award for an amount of time (and/or a quantity of games played and/or an amount of growth of the progressive award). In this example, in association with such a user cryptocurrency pledge event, the system provides the user a benefit of a static fee (e.g., a percentage of the value of the pledged amount of cryptocurrency) and/or a variable fee (e.g., part or all of the portions of wagers placed on one or more plays of one or more games to potentially win the contributed amount of cryptocurrency) for such a pledge.

In certain embodiments, in association with the user's limited duration pledge of the amount of cryptocurrency, the system utilizes the pledged amount of cryptocurrency as collateral to fund the progressive award without converting any amount of cryptocurrency in the user's cryptocurrency wallet to non-cryptocurrency funds (such as cash). For example, responsive to the occurrence of a user's input to pledge, for a limited duration, an amount of cryptocurrency in exchange for a benefit, the system escrows the amount of cryptocurrency and establishes a line of credit based on the escrowed amount of cryptocurrency (i.e., a secured line of credit) to fund the progressive award. In this example, the escrowed amount of cryptocurrency is still owned by the user, but the user is unable to transfer the escrowed amount of cryptocurrency to another account (such as an external cryptocurrency account). In these embodiments, by escrowing the amount of cryptocurrency (instead of transferring ownership of the amount of cryptocurrency or otherwise outright converting the amount of cryptocurrency to another form of currency), the system facilitates avoiding expenses associated with such transactions. In certain other embodiments, in association with the user's limited duration pledge of the amount of cryptocurrency, the system operates to transfer, as described above, the amount of cryptocurrency from the user to a cryptocurrency wallet associated with the system that maintains the progressive award. In certain embodiments, in association with the user's pledge of the amount of cryptocurrency and/or the escrowing of the amount of cryptocurrency, the system associates the amount of cryptocurrency with the progressive award in the distributed ledger.

Following the pledge of the amount of cryptocurrency in exchange for a benefit, the system monitors for a progressive award triggering event in relation to the limited duration. In such embodiments, if a progressive award triggering event occurs during the limited duration, as described above, the system operates to transfer ownership, in the distributed ledger, of the amount of cryptocurrency to the winner of the progressive award. On the other hand, if the progressive award triggering event does not occur during the limited duration, the system operates to disassociate the amount of cryptocurrency from the progressive award while enabling the user to retain the benefit. That is, if the pledged amount of cryptocurrency is not won during the limited duration, the user that pledged the amount of cryptocurrency retains both the amount of cryptocurrency and the benefit provided for pledging the amount of cryptocurrency.

In certain embodiments in which the system escrows the amount of cryptocurrency without otherwise causing any ownership change of the amount of cryptocurrency, the system releases the amount of cryptocurrency from escrow. In certain embodiments in which the system transfers the amount of cryptocurrency from the user to the cryptocurrency wallet associated with the system that maintains the progressive award, upon a determination that no progressive award triggering event occurred during the limited duration, the system transfers the amount of cryptocurrency from the cryptocurrency wallet associated with the system that maintains the progressive award back to the cryptocurrency wallet of the user that received (and retains) the benefit. Accordingly, unlike prior systems that provided users no ability to back any progressive awards, the system of these embodiments enables users to collect a benefit to, at least temporarily, bankroll one or more progressive awards using an amount of cryptocurrency of such users.

In certain embodiments, if the user wants to retain the pledged amount of cryptocurrency prior to the end of the limited duration, the system enables the user to pay a fee to cease pledging the cryptocurrency. In certain such embodiments, the system employs a variable fee structure in which different fees apply based on the duration until the end of the limited duration and/or the current probability of the event (which would cause the user to lose the pledged amount of cryptocurrency) occurring.

In different embodiments, a token creation event, a token association event, a token modification event, a token distribution event, a progressive award increment event, a progressive award triggering event, a cryptocurrency transfer event, and/or a cryptocurrency pledge event occurs based on an outcome associated with one or more plays of any games. In one embodiment, such determinations are symbol driven based on the generation of one or more designated symbols or symbol combinations. In various embodiments, a generation of a designated symbol (or sub-symbol) or a designated set of symbols (or sub-symbols) over one or more plays of a primary game causes such conditions to be satisfied and/or one or more of such events to occur.

In different embodiments, the system does not provide any apparent reasons to the players for an occurrence of a token creation event, a token association event, a token modification event, a token distribution event, a progressive award increment event, a progressive award triggering event, a cryptocurrency transfer event, and/or a cryptocurrency pledge event. In these embodiments, such determinations are not triggered by an event in a game or based specifically on any of the plays of any games. That is, these events occur without any explanation or alternatively with simple explanations.

In one such embodiment, a token creation event, a token association event, a token modification event, a token distribution event, a progressive award increment event, a progressive award triggering event, a cryptocurrency transfer event, and/or a cryptocurrency pledge event occurs based on an amount of coin-in. In this embodiment, the system determines if an amount of coin-in reaches or exceeds a designated amount of coin-in (i.e., a threshold coin-in amount). Upon the amount of coin-in wagered reaching or exceeding the threshold coin-in amount, the system causes one or more of such events or conditions to occur. In another such embodiment, a token creation event, a token association event, a token modification event, a token distribution event, a progressive award increment event, a progressive award triggering event, a cryptocurrency transfer event, and/or a cryptocurrency pledge event occurs based on an amount of virtual currency-in. In this embodiment, the system determines if an amount of virtual currency-in wagered reaches or exceeds a designated amount of virtual currency-in (i.e., a threshold virtual currency-in amount). Upon the amount of virtual currency-in wagered reaching or exceeding the threshold virtual currency-in amount, the system causes one or more of such events or conditions to occur. In different embodiments, the threshold coin-in amount and/or the threshold virtual currency-in amount is predetermined, randomly determined, determined based on a player's status (such as determined through a player tracking system), determined based on a generated symbol or symbol combination, determined based on a random determination by the central controller, determined based on a random determination at the gaming device, determined based on one or more side wagers placed, determined based on the player's primary game wager, determined based on time (such as the time of day) or determined based on any other suitable method or criteria.

In one such embodiment, a token creation event, a token association event, a token modification event, a token distribution event, a progressive award increment event, a progressive award triggering event, a cryptocurrency transfer event, and/or a cryptocurrency pledge event occurs based on an amount of coin-out. In this embodiment, the system determines if an amount of coin-out reaches or exceeds a designated amount of coin-out (i.e., a threshold coin-out amount). Upon the amount of coin-out reaching or exceeding the threshold coin-out amount, the system causes one or more of such events or conditions to occur. In another such embodiment, a token creation event, a token association event, a token modification event, a token distribution event, a progressive award increment event, a progressive award triggering event, a cryptocurrency transfer event, and/or a cryptocurrency pledge event occurs based on an amount of virtual currency-out. In this embodiment, the system determines if an amount of virtual currency-out reaches or exceeds a designated amount of virtual currency-out (i.e., a threshold virtual currency-out amount). Upon the amount of virtual currency-out reaching or exceeding the threshold virtual currency-out amount, the system causes one or more of such events or conditions to occur. In different embodiments, the threshold coin-out amount and/or the threshold virtual currency-out amount is predetermined, randomly determined, determined based on a player's status (such as determined through a player tracking system), determined based on a generated symbol or symbol combination, determined based on a random determination by the central controller, determined based on a random determination at the gaming device, determined based on one or more side wagers placed, determined based on the player's primary game wager, determined based on time (such as the time of day) or determined based on any other suitable method or criteria.

In different embodiments, a token creation event, a token association event, a token modification event, a token distribution event, a progressive award increment event, a progressive award triggering event, a cryptocurrency transfer event, and/or a cryptocurrency pledge event occurs based on a predefined variable reaching a defined parameter threshold. For example, when the 500,000^{th} player has played an EGM (ascertained from a player tracking system), one or more of such events or conditions occur. In different embodiments, the predefined parameter thresholds include a length of time, a length of time after a certain dollar amount is hit, a wager level threshold for a specific device (which EGM is the first to contribute $250,000), a number of EGMs active, or any other parameter that defines a suitable threshold.

In different embodiments, a token creation event, a token association event, a token modification event, a token distribution event, a progressive award increment event, a progressive award triggering event, a cryptocurrency transfer event, and/or a cryptocurrency pledge event occurs based on a quantity of games played. In this embodiment, a quantity of games played is set for when one or more of such events or conditions will occur. In one embodiment, such a set quantity of games played is based on historic data.

In different embodiments, a token creation event, a token association event, a token modification event, a token distribution event, a progressive award increment event, a progressive award triggering event, a cryptocurrency transfer event, and/or a cryptocurrency pledge event occurs based on time. In this embodiment, a time is set for when one or more of such events or conditions will occur. In one embodiment, such a set time is based on historic data.

In different embodiments, a token creation event, a token association event, a token modification event, a token distribution event, a progressive award increment event, a progressive award triggering event, a cryptocurrency transfer event, and/or a cryptocurrency pledge event occurs based upon system operator defined player eligibility parameters stored on a player tracking system (such as via a player tracking card or other suitable manner). In this embodiment, the parameters for eligibility are defined by the system operator based on any suitable criterion. In one embodiment, the system recognizes the player's identification (via the player tracking system) when the player inserts or otherwise associates their player tracking card in the EGM and/or logs into the player tracking system using a mobile device, such as a personal gaming device. The system determines the player tracking level of the player and if the current player tracking level defined by the system operator is eligible for one or more of such events or conditions. In one embodiment, the system operator defines minimum bet levels required for such events or conditions to occur based on the player's card level.

In different embodiments, a token creation event, a token association event, a token modification event, a token distribution event, a progressive award increment event, a progressive award triggering event, a cryptocurrency transfer event, and/or a cryptocurrency pledge event occurs based on a system determination, including one or more random selections by the central controller. For example, as described above, the system tracks all active EGMs and the wagers they placed, wherein based on the EGM's state as well as one or more wager pools associated with the EGM, the system determines whether to one or more of such events or conditions will occur. In one such embodiment, the player who consistently places a higher wager is more likely to be associated with an occurrence of one or more of such events or conditions than a player who consistently places a minimum wager. It should be appreciated that the criteria for determining whether a player is in active status or inactive status for determining if one or more of such events occur may the same as, substantially the same as, or different than the criteria for determining whether a player is in active status or inactive status for another one of such events to occur.

In different embodiments, a token creation event, a token association event, a token modification event, a token distribution event, a progressive award increment event, a progressive award triggering event, a cryptocurrency transfer event, and/or a cryptocurrency pledge event occurs based on a determination of if any numbers allotted to an EGM match a randomly selected number. In this embodiment, upon or prior to each play of each EGM, an EGM selects a random number from a range of numbers and during each primary game, the EGM allocates the first N numbers in the range, where N is the number of credits bet by the player in that primary game. At the end of the primary game, the randomly selected number is compared with the numbers allocated to the player and if a match occurs, one or more of such events or conditions occur.

It should be appreciated that any suitable manner of causing a token creation event, a token association event, a token modification event, a token distribution event, a progressive award increment event, a progressive award triggering event, a cryptocurrency transfer event, and/or a cryptocurrency pledge event to occur may be implemented in accordance with the system and method of the present disclosure. It should be further appreciated that one or more of the above-described triggers pertaining to a token creation event, a token association event, a token modification event, a token distribution event, a progressive award increment event, a progressive award triggering event, a cryptocurrency transfer event, and/or a cryptocurrency pledge event occurring may be combined in one or more different embodiments.

It should be appreciated that in different embodiments, one or more of: whether a token creation event, a token association event, a token modification event, a token distribution event, a progressive award increment event, a progressive award triggering event, a cryptocurrency transfer event, and/or a cryptocurrency pledge event occurs; a type of token to create when a token creation event occurs; one or more properties of a created token; a type of token to modify when a token modification event occurs; one or more properties of a token to modify upon a token modification event; which modification to make to one or more properties of a token; when to distribute a token when a token distribution event occurs; how to distribute a token when a token distribution event occurs; and/or any determination of the present disclosure is/are predetermined, randomly determined, randomly determined based on one or more weighted percentages, determined based on a generated symbol or symbol combination, determined independent of a generated symbol or symbol combination, determined based on a random determination by the central controller, determined independent of a random determination by the central controller, determined based on a random determination at the gaming table component, determined independent of a random determination at the gaming table component, determined based on at least one play of at least one game, determined independent of at least one play of at least one game, determined based on a user's selection, determined independent of a user's selection, determined based on one or more side wagers placed, determined independent of one or more side wagers placed, determined based on the user's primary game wager, determined independent of the user's primary game wager, determined based on time (such as the time of day), determined independent of time (such as the time of day), determined based on an amount of coin-in accumulated in one or more pools, determined independent of an amount of coin-in accumulated in one or more pools, determined based on a status of the user (i.e., a player tracking status), determined independent of a status of the user (i.e., a player tracking status), determined based on one or more other determinations of the present disclosure, determined independent of any other determination of the present disclosure or determined based on any other suitable method or criteria.

The above-described embodiments of the present disclosure may be implemented in accordance with or in conjunction with one or more of a variety of different types of systems, such as, but not limited to, those described below. As such, the present disclosure contemplates a variety of different systems each having one or more of a plurality of different features, attributes, or characteristics. A “system” as used herein refers to various configurations of: (a) one or more servers; (b) one or more electronic gaming machines; and/or (c) one or more personal gaming devices. Thus, in various embodiments, the system of the present disclosure includes: (a) one or more electronic gaming machines in combination with one or more servers; (b) one or more personal gaming devices in combination with one or more servers; (c) one or more personal gaming devices in combination with one or more electronic gaming machines; (d) one or more personal gaming devices, one or more electronic gaming machines, and one or more servers in combination with one another; (e) a single electronic gaming machine; (f) a plurality of electronic gaming machines in combination with one another; (g) a single personal gaming device; (h) a plurality of personal gaming devices in combination with one another; (i) a single server; and/or (j) a plurality of servers in combination with one another. For brevity and clarity and unless specifically stated otherwise, “EGM” as used herein represents one EGM or a plurality of EGMs, “personal gaming device” as used herein represents one personal gaming device or a plurality of personal gaming devices, and “server” as used herein represents one server or a plurality of servers.

As noted above, in various embodiments, the system includes an EGM (or personal gaming device) in combination with a server. In such embodiments, the EGM (or personal gaming device) is configured to communicate with the server through a data network or remote communication link. In certain such embodiments, the EGM (or personal gaming device) is configured to communicate with another EGM (or personal gaming device) through the same data network or remote communication link or through a different data network or remote communication link. For example, the system includes a plurality of EGMs that are each configured to communicate with a server through a data network.

In certain embodiments in which the system includes an EGM (or personal gaming device) in combination with a server, the server is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the server. The at least one processor of that EGM (or personal gaming device) is configured to execute the events, messages, or commands represented by such data or signals in conjunction with the operation of the EGM (or personal gaming device). Moreover, the at least one processor of the server is configured to transmit and receive data or signals representing events, messages, commands, or any other suitable information between the server and the EGM (or personal gaming device). The at least one processor of the server is configured to execute the events, messages, or commands represented by such data or signals in conjunction with the operation of the server. One, more than one, or each of the functions of the server may be performed by the at least one processor of the EGM (or personal gaming device). Further, one, more than one, or each of the functions of the at least one processor of the EGM (or personal gaming device) may be performed by the at least one processor of the server.

In certain such embodiments, computerized instructions for controlling any games (such as any primary or base games and/or any secondary or bonus games) displayed by the EGM (or personal gaming device) are executed by the server. In such “thin client” embodiments, the server remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the server to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the system includes an EGM (or personal gaming device) and a server, computerized instructions for controlling any primary or base games displayed by the EGM (or personal gaming device) are communicated from the server to the EGM (or personal gaming device) in a thick client configuration, and computerized instructions for controlling any secondary or bonus games or other functions displayed by the EGM (or personal gaming device) are executed by the server in a thin client configuration.

In certain embodiments in which the system includes: (a) an EGM (or personal gaming device) configured to communicate with a server through a data network; and/or (b) a plurality of EGMs (or personal gaming devices) configured to communicate with one another through a data network, the data network is a local area network (LAN) in which the EGMs (or personal gaming devices) are located substantially proximate to one another and/or the server. In one example, the EGMs (or personal gaming devices) and the server are located in a gaming establishment or a portion of a gaming establishment.

In other embodiments in which the system includes: (a) an EGM (or personal gaming device) configured to communicate with a server through a data network; and/or (b) a plurality of EGMs (or personal gaming devices) configured to communicate with one another through a data network, the data network is a wide area network (WAN) in which one or more of the EGMs (or personal gaming devices) are not necessarily located substantially proximate to another one of the EGMs (or personal gaming devices) and/or the server. For example, one or more of the EGMs (or personal gaming devices) are located: (a) in an area of a gaming establishment different from an area of the gaming establishment in which the server is located; or (b) in a gaming establishment different from the gaming establishment in which the server is located. In another example, the server is not located within a gaming establishment in which the EGMs (or personal gaming devices) are located. In certain embodiments in which the data network is a WAN, the system includes a server and an EGM (or personal gaming device) each located in a different gaming establishment in a same geographic area, such as a same city or a same state. Systems in which the data network is a WAN are substantially identical to systems in which the data network is a LAN, though the quantity of EGMs (or personal gaming devices) in such systems may vary relative to one another.

In further embodiments in which the system includes: (a) an EGM (or personal gaming device) configured to communicate with a server through a data network; and/or (b) a plurality of EGMs (or personal gaming devices) configured to communicate with one another through a data network, the data network is an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the server identifies a player before enabling that player to place any wagers on any plays of any wagering games. In one example, the server identifies the player by requiring a player account of the player to be logged into via an input of a unique username and password combination assigned to the player. The server may, however, identify the player in any other suitable manner, such as by validating a player tracking identification number associated with the player; by reading a player tracking card or other smart card inserted into a card reader (as described below); by validating a unique player identification number associated with the player by the server; or by identifying the EGM (or personal gaming device), such as by identifying the MAC address or the IP address of the Internet facilitator. In various embodiments, once the server identifies the player, the server enables placement of one or more wagers on one or more plays of one or more primary or base games and/or one or more secondary or bonus games, and displays those plays via the Internet browser of the EGM (or personal gaming device).

The server and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

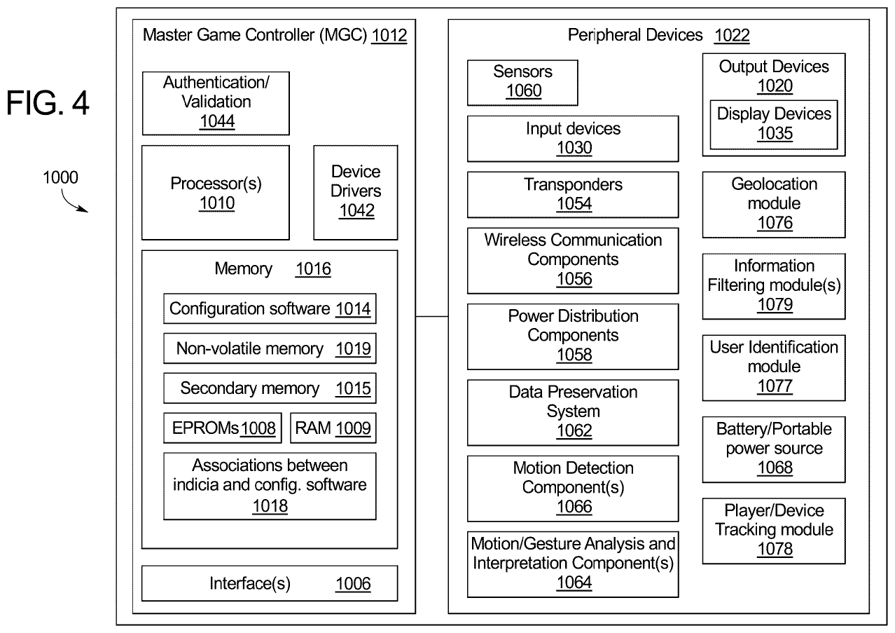

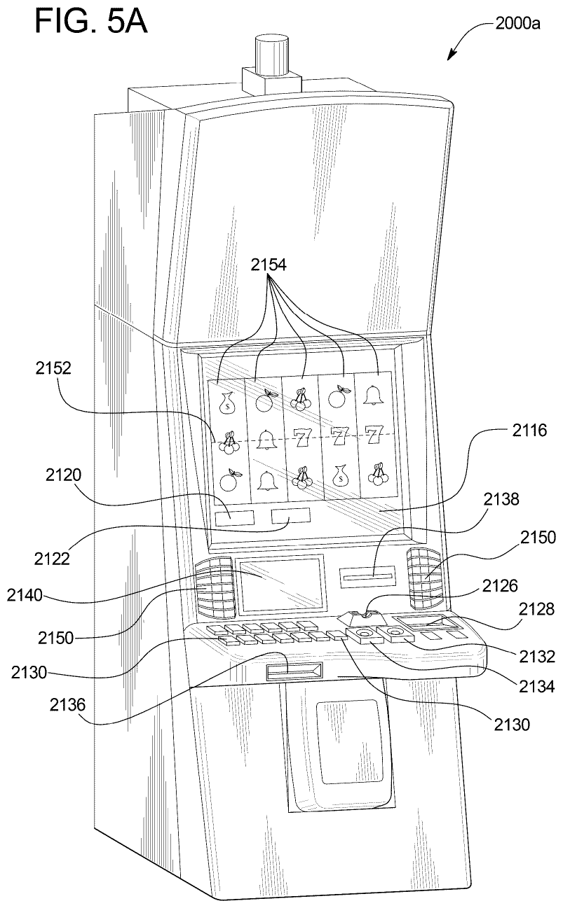

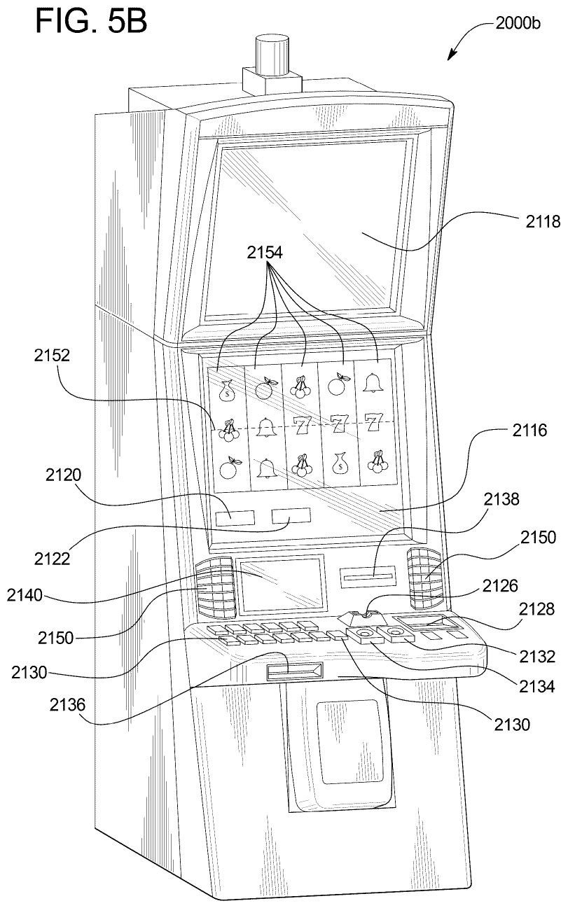

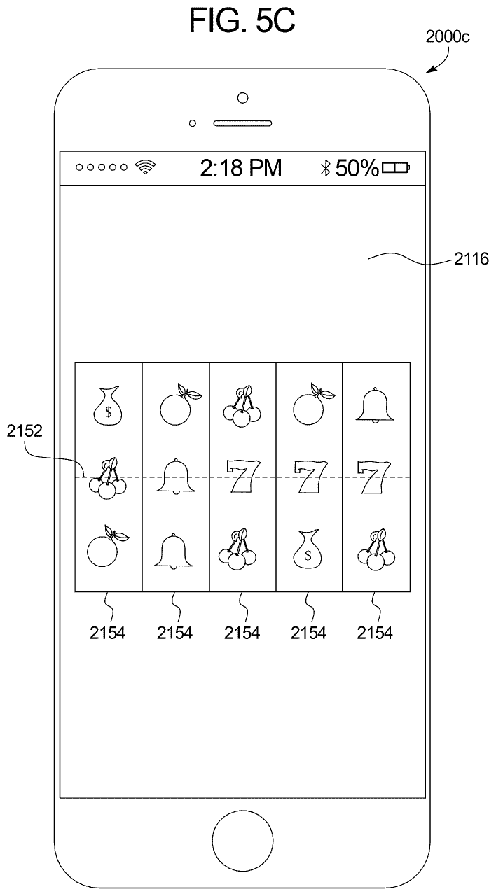

FIG. 4 is a block diagram of an example EGM 1000 and FIGS. 5A and 5B include two different example EGMs 2000a and 2000b. The EGMs 1000, 2000a, and 2000b are merely example EGMs, and different EGMs may be implemented using different combinations of the components shown in the EGMs 1000, 2000a, and 2000b. Although the below refers to EGMs, in various embodiments personal gaming devices (such as personal gaming device 2000c of FIG. 5C) may include some or all of the below components.

In these embodiments, the EGM 1000 includes a master gaming controller 1012 configured to communicate with and to operate with a plurality of peripheral devices 1022.

The master gaming controller 1012 includes at least one processor 1010. The at least one processor 1010 is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or game information) via a communication interface 1006 of the master gaming controller 1012; (2) converting signals read by an interface to a format corresponding to that used by software or memory of the EGM; (3) accessing memory to configure or reconfigure game parameters in the memory according to indicia read from the EGM; (4) communicating with interfaces and the peripheral devices 1022 (such as input/output devices); and/or (5) controlling the peripheral devices 1022. In certain embodiments, one or more components of the master gaming controller 1012 (such as the at least one processor 1010) reside within a housing of the EGM (described below), while in other embodiments at least one component of the master gaming controller 1012 resides outside of the housing of the EGM.

The master gaming controller 1012 also includes at least one memory device 1016, which includes: (1) volatile memory (e.g., RAM 1009, which can include non-volatile RAM, magnetic RAM, ferroelectric RAM, and any other suitable forms); (2) non-volatile memory 1019 (e.g., disk memory, FLASH memory, EPROMs, EEPROMs, memristor-based non-volatile solid-state memory, etc.); (3) unalterable memory (e.g., EPROMs 1008); (4) read-only memory; and/or (5) a secondary memory storage device 1015, such as a non-volatile memory device, configured to store gaming software related information (the gaming software related information and the memory may be used to store various audio files and games not currently being used and invoked in a configuration or reconfiguration). Any other suitable magnetic, optical, and/or semiconductor memory may operate in conjunction with the EGM of the present disclosure. In certain embodiments, the at least one memory device 1016 resides within the housing of the EGM (described below), while in other embodiments at least one component of the at least one memory device 1016 resides outside of the housing of the EGM. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device 1016 is configured to store, for example: (1) configuration software 1014, such as all the parameters and settings for a game playable on the EGM; (2) associations 1018 between configuration indicia read from an EGM with one or more parameters and settings; (3) communication protocols configured to enable the at least one processor 1010 to communicate with the peripheral devices 1022; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the EGM to communicate with local and non-local devices using such protocols. In one implementation, the master gaming controller 1012 communicates with other devices using a serial communication protocol. A few non-limiting examples of serial communication protocols that other devices, such as peripherals (e.g., a bill validator or a ticket printer), may use to communicate with the master game controller 1012 include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “cmodule,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device 1016 is configured to store program code and instructions executable by the at least one processor of the EGM to control the EGM. The at least one memory device 1016 of the EGM also stores other operating data, such as image data, event data, input data, random number generators (RNGs) or pseudo-RNGs, paytable data or information, and/or applicable game rules that relate to the play of one or more games on the EGM. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a player uses such a removable memory device in an EGM to implement at least part of the present disclosure. In other embodiments, part or all of the program code and/or the operating data is downloaded to the at least one memory device of the EGM through any suitable data network described above (such as an Internet or intranet).

The at least one memory device 1016 also stores a plurality of device drivers 1042. Examples of different types of device drivers include device drivers for EGM components and device drivers for the peripheral components 1022. Typically, the device drivers 1042 utilize various communication protocols that enable communication with a particular physical device. The device driver abstracts the hardware implementation of that device. For example, a device driver may be written for each type of card reader that could potentially be connected to the EGM. Non-limiting examples of communication protocols used to implement the device drivers include Netplex, USB, Serial, Ethernet 175, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the EGM loads the new device driver from the at least one memory device to enable communication with the new device. For instance, one type of card reader in the EGM can be replaced with a second different type of card reader when device drivers for both card readers are stored in the at least one memory device.

In certain embodiments, the software units stored in the at least one memory device 1016 can be upgraded as needed. For instance, when the at least one memory device 1016 is a hard drive, new games, new game options, new parameters, new settings for existing parameters, new settings for new parameters, new device drivers, and new communication protocols can be uploaded to the at least one memory device 1016 from the master game controller 1012 or from some other external device. As another example, when the at least one memory device 1016 includes a CD/DVD drive including a CD/DVD configured to store game options, parameters, and settings, the software stored in the at least one memory device 1016 can be upgraded by replacing a first CD/DVD with a second CD/DVD. In yet another example, when the at least one memory device 1016 uses flash memory 1019 or EPROM 1008 units configured to store games, game options, parameters, and settings, the software stored in the flash and/or EPROM memory units can be upgraded by replacing one or more memory units with new memory units that include the upgraded software. In another embodiment, one or more of the memory devices, such as the hard drive, may be employed in a game software download process from a remote software server.

In some embodiments, the at least one memory device 1016 also stores authentication and/or validation components 1044 configured to authenticate/validate specified EGM components and/or information, such as hardware components, software components, firmware components, peripheral device components, user input device components, information received from one or more user input devices, information stored in the at least one memory device 1016, etc.

In certain embodiments, the peripheral devices 1022 include several device interfaces, such as: (1) at least one output device 1020 including at least one display device 1035; (2) at least one input device 1030 (which may include contact and/or non-contact interfaces); (3) at least one transponder 1054; (4) at least one wireless communication component 1056; (5) at least one wired/wireless power distribution component 1058; (6) at least one sensor 1060; (7) at least one data preservation component 1062; (8) at least one motion/gesture analysis and interpretation component 1064; (9) at least one motion detection component 1066; (10) at least one portable power source 1068; (11) at least one geolocation module 1076; (12) at least one user identification module 1077; (13) at least one player/device tracking module 1078; and (14) at least one information filtering module 1079.

The at least one output device 1020 includes at least one display device 1035 configured to display any game(s) displayed by the EGM and any suitable information associated with such game(s). In certain embodiments, the display devices are connected to or mounted on a housing of the EGM (described below). In various embodiments, the display devices serve as digital glass configured to advertise certain games or other aspects of the gaming establishment in which the EGM is located. In various embodiments, the EGM includes one or more of the following display devices: (a) a central display device; (b) a player tracking display configured to display various information regarding a player's player tracking status (as described below); (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games. The example EGM 2000a illustrated in FIG. 5A includes a central display device 2116, a player tracking display 2140, a credit display 2120, and a bet display 2122. The example EGM 2000b illustrated in FIG. 5B includes a central display device 2116, an upper display device 2118, a player tracking display 2140, a credit display 2120, and a bet display 2122.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

The display devices of the EGM are configured to display one or more game and/or non-game images, symbols, and indicia. In certain embodiments, the display devices of the EGM are configured to display any suitable visual representation or exhibition of the movement of objects; dynamic lighting; video images; images of people, characters, places, things, and faces of cards; and the like. In certain embodiments, the display devices of the EGM are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, the at least one output device 1020 includes a payout device. In these embodiments, after the EGM receives an actuation of a cashout device (described below), the EGM causes the payout device to provide a payment to the player. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. The example EGMs 2000a and 2000b illustrated in FIGS. 5A and 5B each include a ticket printer and dispenser 2136.

In certain embodiments, rather than dispensing bills, coins, or a physical ticket having a monetary value to the player following receipt of an actuation of the cashout device, the payout device is configured to cause a payment to be provided to the player in the form of an electronic funds transfer, such as via a direct deposit into a bank account, a casino account, or a prepaid account of the player; via a transfer of funds onto an electronically recordable identification card or smart card of the player; or via sending a virtual ticket having a monetary value to an electronic device of the player.

While any credit balances, any wagers, any values, and any awards are described herein as amounts of monetary credits or currency, one or more of such credit balances, such wagers, such values, and such awards may be for non-monetary credits, promotional credits, of player tracking points or credits.

In certain embodiments, the at least one output device 1020 is a sound generating device controlled by one or more sound cards. In one such embodiment, the sound generating device includes one or more speakers or other sound generating hardware and/or software configured to generate sounds, such as by playing music for any games or by playing music for other modes of the EGM, such as an attract mode. The example EGMs 2000a and 2000b illustrated in FIGS. 5A and 5B each include a plurality of speakers 2150. In another such embodiment, the EGM provides dynamic sounds coupled with attractive multimedia images displayed on one or more of the display devices to provide an audio-visual representation or to otherwise display full-motion video with sound to attract players to the EGM. In certain embodiments, the EGM displays a sequence of audio and/or visual attraction messages during idle periods to attract potential players to the EGM. The videos may be customized to provide any appropriate information.

The at least one input device 1030 may include any suitable device that enables an input signal to be produced and received by the at least one processor 1010 of the EGM.

In one embodiment, the at least one input device 1030 includes a payment device configured to communicate with the at least one processor of the EGM to fund the EGM. In certain embodiments, the payment device includes one or more of: (a) a bill acceptor into which paper money is inserted to fund the EGM; (b) a ticket acceptor into which a ticket or a voucher is inserted to fund the EGM; (c) a coin slot into which coins or tokens are inserted to fund the EGM; (d) a reader or a validator for credit cards, debit cards, or credit slips into which a credit card, debit card, or credit slip is inserted to fund the EGM; (e) a player identification card reader into which a player identification card is inserted to fund the EGM; or (f) any suitable combination thereof. The example EGMs 2000a and 2000b illustrated in FIGS. 5A and 5B each include a combined bill and ticket acceptor 2128 and a coin slot 2126.

In one embodiment, the at least one input device 1030 includes a payment device configured to enable the EGM to be funded via an electronic funds transfer, such as a transfer of funds from a bank account. In another embodiment, the EGM includes a payment device configured to communicate with a mobile device of a player, such as a mobile phone, a radio frequency identification tag, or any other suitable wired or wireless device, to retrieve relevant information associated with that player to fund the EGM. When the EGM is funded, the at least one processor determines the amount of funds entered and displays the corresponding amount on a credit display or any other suitable display as described below.

In certain embodiments, the at least one input device 1030 includes at least one wagering or betting device. In various embodiments, the one or more wagering or betting devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). One such wagering or betting device is as a maximum wager or bet device that, when actuated, causes the EGM to place a maximum wager on a play of a game. Another such wagering or betting device is a repeat bet device that, when actuated, causes the EGM to place a wager that is equal to the previously-placed wager on a play of a game. A further such wagering or betting device is a bet one device that, when actuated, causes the EGM to increase the wager by one credit. Generally, upon actuation of one of the wagering or betting devices, the quantity of credits displayed in a credit meter (described below) decreases by the amount of credits wagered, while the quantity of credits displayed in a bet display (described below) increases by the amount of credits wagered.

In various embodiments, the at least one input device 1030 includes at least one game play activation device. In various embodiments, the one or more game play initiation devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). After a player appropriately funds the EGM and places a wager, the EGM activates the game play activation device to enable the player to actuate the game play activation device to initiate a play of a game on the EGM (or another suitable sequence of events associated with the EGM). After the EGM receives an actuation of the game play activation device, the EGM initiates the play of the game. The example EGMs 2000a and 2000b illustrated in FIGS. 5A and 5B each include a game play activation device in the form of a game play initiation button 2132. In other embodiments, the EGM begins game play automatically upon appropriate funding rather than upon utilization of the game play activation device.

In other embodiments, the at least one input device 1030 includes a cashout device. In various embodiments, the cashout device is: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). When the EGM receives an actuation of the cashout device from a player and the player has a positive (i.e., greater-than-zero) credit balance, the EGM initiates a payout associated with the player's credit balance. The example EGMs 2000a and 2000b illustrated in FIGS. 5A and 5B each include a cashout device in the form of a cashout button 2134.

In various embodiments, the at least one input device 1030 includes a plurality of buttons that are programmable by the EGM operator to, when actuated, cause the EGM to perform particular functions. For instance, such buttons may be hard keys, programmable soft keys, or icons icon displayed on a display device of the EGM (described below) that are actuatable via a touch screen of the EGM (described below) or via use of a suitable input device of the EGM (such as a mouse or a joystick). The example EGMs 2000a and 2000b illustrated in FIGS. 5A and 5B each include a plurality of such buttons 2130.

In certain embodiments, the at least one input device 1030 includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the EGM by touching the touch screen at the appropriate locations.

In embodiments including a player tracking system, as further described below, the at least one input device 1030 includes a card reader in communication with the at least one processor of the EGM. The example EGMs 2000a and 2000b illustrated in FIGS. 5A and 5B each include a card reader 2138. The card reader is configured to read a player identification card inserted into the card reader.

The at least one wireless communication component 1056 includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component 1056 transmits electrical, electromagnetic, or optical signals that carry digital data streams or analog signals representing various types of information.

The at least one wired/wireless power distribution component 1058 includes components or devices that are configured to provide power to other devices. For example, in one embodiment, the at least one power distribution component 1058 includes a magnetic induction system that is configured to provide wireless power to one or more user input devices near the EGM. In one embodiment, a user input device docking region is provided, and includes a power distribution component that is configured to recharge a user input device without requiring metal-to-metal contact. In one embodiment, the at least one power distribution component 1058 is configured to distribute power to one or more internal components of the EGM, such as one or more rechargeable power sources (e.g., rechargeable batteries) located at the EGM.

In certain embodiments, the at least one sensor 1060 includes at least one of: optical sensors, pressure sensors, RF sensors, infrared sensors, image sensors, thermal sensors, and biometric sensors. The at least one sensor 1060 may be used for a variety of functions, such as: detecting movements and/or gestures of various objects within a predetermined proximity to the EGM; detecting the presence and/or identity of various persons (e.g., players, casino employees, etc.), devices (e.g., user input devices), and/or systems within a predetermined proximity to the EGM.

The at least one data preservation component 1062 is configured to detect or sense one or more events and/or conditions that, for example, may result in damage to the EGM and/or that may result in loss of information associated with the EGM. Additionally, the data preservation system 1062 may be operable to initiate one or more appropriate action(s) in response to the detection of such events/conditions.

The at least one motion/gesture analysis and interpretation component 1064 is configured to analyze and/or interpret information relating to detected player movements and/or gestures to determine appropriate player input information relating to the detected player movements and/or gestures. For example, in one embodiment, the at least one motion/gesture analysis and interpretation component 1064 is configured to perform one or more of the following functions: analyze the detected gross motion or gestures of a player; interpret the player's motion or gestures (e.g., in the context of a casino game being played) to identify instructions or input from the player; utilize the interpreted instructions/input to advance the game state; etc. In other embodiments, at least a portion of these additional functions may be implemented at a remote system or device.

The at least one portable power source 1068 enables the EGM to operate in a mobile environment. For example, in one embodiment, the EGM 300 includes one or more rechargeable batteries.

The at least one geolocation module 1076 is configured to acquire geolocation information from one or more remote sources and use the acquired geolocation information to determine information relating to a relative and/or absolute position of the EGM. For example, in one implementation, the at least one geolocation module 1076 is configured to receive GPS signal information for use in determining the position or location of the EGM. In another implementation, the at least one geolocation module 1076 is configured to receive multiple wireless signals from multiple remote devices (e.g., EGMs, servers, wireless access points, etc.) and use the signal information to compute position/location information relating to the position or location of the EGM.

The at least one user identification module 1077 is configured to determine the identity of the current user or current owner of the EGM. For example, in one embodiment, the current user is required to perform a login process at the EGM in order to access one or more features. Alternatively, the EGM is configured to automatically determine the identity of the current user based on one or more external signals, such as an RFID tag or badge worn by the current user and that provides a wireless signal to the EGM that is used to determine the identity of the current user. In at least one embodiment, various security features are incorporated into the EGM to prevent unauthorized users from accessing confidential or sensitive information.

The at least one information filtering module 1079 is configured to perform filtering (e.g., based on specified criteria) of selected information to be displayed at one or more displays 1035 of the EGM.

In various embodiments, the EGM includes a plurality of communication ports configured to enable the at least one processor of the EGM to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, such as the example EGMs 2000a and 2000b illustrated in FIGS. 5A and 5B, the EGM has a support structure, housing, or cabinet that provides support for a plurality of the input devices and the output devices of the EGM. Further, the EGM is configured such that a player may operate it while standing or sitting. In various embodiments, the EGM is positioned on a base or stand, or is configured as a pub-style tabletop game (not shown) that a player may operate typically while sitting. As illustrated by the different example EGMs 2000a and 2000b shown in FIGS. 5A and 5B, EGMs may have varying housing and display configurations.

In certain embodiments, the EGM is a device that has obtained approval from a regulatory gaming commission, and in other embodiments, the EGM is a device that has not obtained approval from a regulatory gaming commission.

The EGMs described above are merely three examples of different types of EGMs. Certain of these example EGMs may include one or more elements that may not be included in all systems, and these example EGMs may not include one or more elements that are included in other systems. For example, certain EGMs include a coin acceptor while others do not.

In various embodiments, an EGM may be implemented in one of a variety of different configurations. In various embodiments, the EGM may be implemented as one of: (a) a dedicated EGM in which computerized game programs executable by the EGM for controlling any primary or base games (referred to herein as “primary games”) and/or any secondary or bonus games or other functions (referred to herein as “secondary games”) displayed by the EGM are provided with the EGM before delivery to a gaming establishment or before being provided to a player; and (b) a changeable EGM in which computerized game programs executable by the EGM for controlling any primary games and/or secondary games displayed by the EGM are downloadable or otherwise transferred to the EGM through a data network or remote communication link; from a USB drive, flash memory card, or other suitable memory device; or in any other suitable manner after the EGM is physically located in a gaming establishment or after the EGM is provided to a player.

As generally explained above, in various embodiments in which the system includes a server and a changeable EGM, the at least one memory device of the server stores different game programs and instructions executable by the at least one processor of the changeable EGM to control one or more primary games and/or secondary games displayed by the changeable EGM. More specifically, each such executable game program represents a different game or a different type of game that the at least one changeable EGM is configured to operate. In one example, certain of the game programs are executable by the changeable EGM to operate games having the same or substantially the same game play but different paytables. In different embodiments, each executable game program is associated with a primary game, a secondary game, or both. In certain embodiments, an executable game program is executable by the at least one processor of the at least one changeable EGM as a secondary game to be played simultaneously with a play of a primary game (which may be downloaded to or otherwise stored on the at least one changeable EGM), or vice versa.

In operation of such embodiments, the server is configured to communicate one or more of the stored executable game programs to the at least one processor of the changeable EGM. In different embodiments, a stored executable game program is communicated or delivered to the at least one processor of the changeable EGM by: (a) embedding the executable game program in a device or a component (such as a microchip to be inserted into the changeable EGM); (b) writing the executable game program onto a disc or other media; or (c) uploading or streaming the executable game program over a data network (such as a dedicated data network). After the executable game program is communicated from the server to the changeable EGM, the at least one processor of the changeable EGM executes the executable game program to enable the primary game and/or the secondary game associated with that executable game program to be played using the display device(s) and/or the input device(s) of the changeable EGM. That is, when an executable game program is communicated to the at least one processor of the changeable EGM, the at least one processor of the changeable EGM changes the game or the type of game that may be played using the changeable EGM.

In certain embodiments, the system randomly determines any game outcome(s) (such as a win outcome) and/or award(s) (such as a quantity of credits to award for the win outcome) for a play of a primary game and/or a play of a secondary game based on probability data. In certain such embodiments, this random determination is provided through utilization of an RNG, such as a true RNG or a pseudo RNG, or any other suitable randomization process. In one such embodiment, each game outcome or award is associated with a probability, and the system generates the game outcome(s) and/or the award(s) to be provided based on the associated probabilities. In these embodiments, since the system generates game outcomes and/or awards randomly or based on one or more probability calculations, there is no certainty that the system will ever provide any specific game outcome and/or award.

In certain embodiments, the system maintains one or more predetermined pools or sets of predetermined game outcomes and/or awards. In certain such embodiments, upon generation or receipt of a game outcome and/or award request, the system independently selects one of the predetermined game outcomes and/or awards from the one or more pools or sets. The system flags or marks the selected game outcome and/or award as used. Once a game outcome or an award is flagged as used, it is prevented from further selection from its respective pool or set; that is, the system does not select that game outcome or award upon another game outcome and/or award request. The system provides the selected game outcome and/or award.

In certain embodiments, the system determines a predetermined game outcome and/or award based on the results of a bingo, keno, or lottery game. In certain such embodiments, the system utilizes one or more bingo, keno, or lottery games to determine the predetermined game outcome and/or award provided for a primary game and/or a secondary game. The system is provided or associated with a bingo card. Each bingo card consists of a matrix or array of elements, wherein each element is designated with separate indicia. After a bingo card is provided, the system randomly selects or draws a plurality of the elements. As each element is selected, a determination is made as to whether the selected element is present on the bingo card. If the selected element is present on the bingo card, that selected element on the provided bingo card is marked or flagged. This process of selecting elements and marking any selected elements on the provided bingo cards continues until one or more predetermined patterns are marked on one or more of the provided bingo cards. After one or more predetermined patterns are marked on one or more of the provided bingo cards, game outcome and/or award is determined based, at least in part, on the selected elements on the provided bingo cards.

In certain embodiments in which the system includes a server and an EGM, the EGM is configured to communicate with the server for monitoring purposes only. In such embodiments, the EGM determines the game outcome(s) and/or award(s) to be provided in any of the manners described above, and the server monitors the activities and events occurring on the EGM. In one such embodiment, the system includes a real-time or online accounting and gaming information system configured to communicate with the server. In this embodiment, the accounting and gaming information system includes: (a) a player database configured to store player profiles, (b) a player tracking module configured to track players (as described below), and (c) a credit system configured to provide automated transactions.

As noted above, in various embodiments, the system includes one or more executable game programs executable by at least one processor of the system to provide one or more primary games and one or more secondary games. The primary game(s) and the secondary game(s) may comprise any suitable games and/or wagering games, such as, but not limited to: electro-mechanical or video slot or spinning reel type games; video card games such as video draw poker, multi-hand video draw poker, other video poker games, video blackjack games, and video baccarat games; video keno games; video bingo games; and video selection games.

In certain embodiments in which the primary game is a slot or spinning reel type game, the system includes one or more reels in either an electromechanical form with mechanical rotating reels or in a video form with simulated reels and movement thereof. Each reel displays a plurality of indicia or symbols, such as bells, hearts, fruits, numbers, letters, bars, or other images that typically correspond to a theme associated with the system. In certain such embodiments, the system includes one or more paylines associated with the reels. The example EGM 2000b shown in FIG. 5B includes a payline 2152 and a plurality of reels 2154. In certain embodiments, one or more of the reels are independent reels or unisymbol reels. In such embodiments, each independent reel generates and displays one symbol.

In various embodiments, one or more of the paylines is horizontal, vertical, circular, diagonal, angled, or any suitable combination thereof. In other embodiments, each of one or more of the paylines is associated with a plurality of adjacent symbol display areas on a requisite number of adjacent reels. In one such embodiment, one or more paylines are formed between at least two symbol display areas that are adjacent to each other by either sharing a common side or sharing a common corner (i.e., such paylines are connected paylines). The system enables a wager to be placed on one or more of such paylines to activate such paylines. In other embodiments in which one or more paylines are formed between at least two adjacent symbol display areas, the system enables a wager to be placed on a plurality of symbol display areas, which activates those symbol display areas.

In various embodiments, the system provides one or more awards after a spin of the reels when specified types and/or configurations of the indicia or symbols on the reels occur on an active payline or otherwise occur in a winning pattern, occur on the requisite number of adjacent reels, and/or occur in a scatter pay arrangement.

In certain embodiments, the system employs a ways to win award determination. In these embodiments, any outcome to be provided is determined based on a number of associated symbols that are generated in active symbol display areas on the requisite number of adjacent reels (i.e., not on paylines passing through any displayed winning symbol combinations). If a winning symbol combination is generated on the reels, one award for that occurrence of the generated winning symbol combination is provided.

In various embodiments, the system includes a progressive award. Typically, a progressive award includes an initial amount and an additional amount funded through a portion of each wager placed to initiate a play of a primary game. When one or more triggering events occurs, the system provides at least a portion of the progressive award. After the system provides the progressive award, an amount of the progressive award is reset to the initial amount and a portion of each subsequent wager is allocated to the next progressive award.

As generally noted above, in addition to providing winning credits or other awards for one or more plays of the primary game(s), in various embodiments the system provides credits or other awards for one or more plays of one or more secondary games. The secondary game typically enables an award to be obtained addition to any award obtained through play of the primary game(s). The secondary game(s) typically produces a higher level of player excitement than the primary game(s) because the secondary game(s) provides a greater expectation of winning than the primary game(s) and is accompanied with more attractive or unusual features than the primary game(s). The secondary game(s) may be any type of suitable game, either similar to or completely different from the primary game.

In various embodiments, the system automatically provides or initiates the secondary game upon the occurrence of a triggering event or the satisfaction of a qualifying condition. In other embodiments, the system initiates the secondary game upon the occurrence of the triggering event or the satisfaction of the qualifying condition and upon receipt of an initiation input. In certain embodiments, the triggering event or qualifying condition is a selected outcome in the primary game(s) or a particular arrangement of one or more indicia on a display device for a play of the primary game(s), such as a “BONUS” symbol appearing on three adjacent reels along a payline following a spin of the reels for a play of the primary game. In other embodiments, the triggering event or qualifying condition occurs based on a certain amount of game play (such as number of games, number of credits, amount of time) being exceeded, or based on a specified number of points being earned during game play. Any suitable triggering event or qualifying condition or any suitable combination of a plurality of different triggering events or qualifying conditions may be employed.

In other embodiments, at least one processor of the system randomly determines when to provide one or more plays of one or more secondary games. In one such embodiment, no apparent reason is provided for providing the secondary game. In this embodiment, qualifying for a secondary game is not triggered by the occurrence of an event in any primary game or based specifically on any of the plays of any primary game. That is, qualification is provided without any explanation or, alternatively, with a simple explanation. In another such embodiment, the system determines qualification for a secondary game at least partially based on a game triggered or symbol triggered event, such as at least partially based on play of a primary game.

In various embodiments, after qualification for a secondary game has been determined, the secondary game participation may be enhanced through continued play on the primary game. Thus, in certain embodiments, for each secondary game qualifying event, such as a secondary game symbol, that is obtained, a given number of secondary game wagering points or credits is accumulated in a “secondary game meter” configured to accrue the secondary game wagering credits or entries toward eventual participation in the secondary game. In one such embodiment, the occurrence of multiple such secondary game qualifying events in the primary game results in an arithmetic or exponential increase in the number of secondary game wagering credits awarded. In another such embodiment, any extra secondary game wagering credits may be redeemed during the secondary game to extend play of the secondary game.

In certain embodiments, no separate entry fee or buy-in for the secondary game is required. That is, entry into the secondary game cannot be purchased; rather, in these embodiments entry must be won or earned through play of the primary game, thereby encouraging play of the primary game. In other embodiments, qualification for the secondary game is accomplished through a simple “buy-in.” For example, qualification through other specified activities is unsuccessful, payment of a fee or placement of an additional wager “buys-in” to the secondary game. In certain embodiments, a separate side wager must be placed on the secondary game or a wager of a designated amount must be placed on the primary game to enable qualification for the secondary game. In these embodiments, the secondary game triggering event must occur and the side wager (or designated primary game wager amount) must have been placed for the secondary game to trigger.

In various embodiments in which the system includes a plurality of EGMs, the EGMs are configured to communicate with one another to provide a group gaming environment. In certain such embodiments, the EGMs enable players of those EGMs to work in conjunction with one another, such as by enabling the players to play together as a team or group, to win one or more awards. In other such embodiments, the EGMs enable players of those EGMs to compete against one another for one or more awards. In one such embodiment, the EGMs enable the players of those EGMs to participate in one or more gaming tournaments for one or more awards.

In various embodiments, the system includes one or more player tracking systems. Such player tracking systems enable operators of the system (such as casinos or other gaming establishments) to recognize the value of customer loyalty by identifying frequent customers and rewarding them for their patronage. Such a player tracking system is configured to track a player's gaming activity. In one such embodiment, the player tracking system does so through the use of player tracking cards. In this embodiment, a player is issued a player identification card that has an encoded player identification number that uniquely identifies the player. When the player's playing tracking card is inserted into a card reader of the system to begin a gaming session, the card reader reads the player identification number off the player tracking card to identify the player. The system timely tracks any suitable information or data relating to the identified player's gaming session. The system also timely tracks when the player tracking card is removed to conclude play for that gaming session. In another embodiment, rather than requiring insertion of a player tracking card into the card reader, the system utilizes one or more portable devices, such as a mobile phone, a radio frequency identification tag, or any other suitable wireless device, to track when a gaming session begins and ends. In another embodiment, the system utilizes any suitable biometric technology or ticket technology to track when a gaming session begins and ends.

In such embodiments, during one or more gaming sessions, the system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device.

In various embodiments, the system includes one or more servers configured to communicate with a personal gaming device—such as a smartphone, a tablet computer, a desktop computer, or a laptop computer—to enable web-based game play using the personal gaming device. In various embodiments, the player must first access a gaming website via an Internet browser of the personal gaming device or execute an application (commonly called an “app”) installed on the personal gaming device before the player can use the personal gaming device to participate in web-based game play. In certain embodiments, the one or more servers and the personal gaming device operate in a thin-client environment. In these embodiments, the personal gaming device receives inputs via one or more input devices (such as a touch screen and/or physical buttons), the personal gaming device sends the received inputs to the one or more servers, the one or more servers make various determinations based on the inputs and determine content to be displayed (such as a randomly determined game outcome and corresponding award), the one or more servers send the content to the personal gaming device, and the personal gaming device displays the content.

In certain such embodiments, the one or more servers must identify the player before enabling game play on the personal gaming device (or, in some embodiments, before enabling monetary wager-based game play on the personal gaming device). In these embodiments, the player must identify herself to the one or more servers, such as by inputting the player's unique username and password combination, providing an input to a biometric sensor (e.g., a fingerprint sensor, a retinal sensor, a voice sensor, or a facial-recognition sensor), or providing any other suitable information.

Once identified, the one or more servers enable the player to establish an account balance from which the player can draw credits usable to wager on plays of a game. In certain embodiments, the one or more servers enable the player to initiate an electronic funds transfer to transfer funds from a bank account to the player's account balance. In other embodiments, the one or more servers enable the player to make a payment using the player's credit card, debit card, or other suitable device to add money to the player's account balance. In other embodiments, the one or more servers enable the player to add money to the player's account balance via a peer-to-peer type application, such as PayPal or Venmo. The one or more servers also enable the player to cash out the player's account balance (or part of it) in any suitable manner, such as via an electronic funds transfer, by initiating creation of a paper check that is mailed to the player, or by initiating printing of a voucher at a kiosk in a gaming establishment.

In certain embodiments, the one or more servers include a payment server that handles establishing and cashing out players' account balances and a separate game server configured to determine the outcome and any associated award for a play of a game. In these embodiments, the game server is configured to communicate with the personal gaming device and the payment device, and the personal gaming device and the payment device are not configured to directly communicate with one another. In these embodiments, when the game server receives data representing a request to start a play of a game at a desired wager, the game server sends data representing the desired wager to the payment server. The payment server determines whether the player's account balance can cover the desired wager (i.e., includes a monetary balance at least equal to the desired wager).

If the payment server determines that the player's account balance cannot cover the desired wager, the payment server notifies the game server, which then instructs the personal gaming device to display a suitable notification to the player that the player's account balance is too low to place the desired wager. If the payment server determines that the player's account balance can cover the desired wager, the payment server deducts the desired wager from the account balance and notifies the game server. The game server then determines an outcome and any associated award for the play of the game. The game server notifies the payment server of any nonzero award, and the payment server increases the player's account balance by the nonzero award. The game server sends data representing the outcome and any award to the personal gaming device, which displays the outcome and any award.

In certain embodiments, the one or more servers enable web-based game play using a personal gaming device only if the personal gaming device satisfies one or more jurisdictional requirements. In one embodiment, the one or more servers enable web-based game play using the personal gaming device only if the personal gaming device is located within a designated geographic area (such as within certain state or county lines or within the boundaries of a gaming establishment). In this embodiment, the geolocation module of the personal gaming device determines the location of the personal gaming device and sends the location to the one or more servers, which determine whether the personal gaming device is located within the designated geographic area. In various embodiments, the one or more servers enable non-monetary wager-based game play if the personal gaming device is located outside of the designated geographic area.

In various embodiments, the system includes an EGM configured to communicate with a personal gaming device—such as a smartphone, a tablet computer, a desktop computer, or a laptop computer—to enable tethered mobile game play using the personal gaming device. Generally, in these embodiments, the EGM establishes communication with the personal gaming device and enables the player to play games on the EGM remotely via the personal gaming device. In certain embodiments, the system includes a geo-fence system that enables tethered game play within a particular geographic area but not outside of that geographic area.

In certain embodiments, the system is configured to communicate with a social network server that hosts or partially hosts a social networking website via a data network (such as the Internet) to integrate a player's gaming experience with the player's social networking account. This enables the system to send certain information to the social network server that the social network server can use to create content (such as text, an image, and/or a video) and post it to the player's wall, newsfeed, or similar area of the social networking website accessible by the player's connections (and in certain cases the public) such that the player's connections can view that information. This also enables the system to receive certain information from the social network server, such as the player's likes or dislikes or the player's list of connections. In certain embodiments, the system enables the player to link the player's player account to the player's social networking account(s). This enables the system to, once it identifies the player and initiates a gaming session (such as via the player logging in to a website (or an application) on the player's personal gaming device or via the player inserting the player's player tracking card into an EGM), link that gaming session to the player's social networking account(s). In other embodiments, the system enables the player to link the player's social networking account(s) to individual gaming sessions when desired by providing the required login information.

For instance, in one embodiment, if a player wins a particular award (e.g., a progressive award or a jackpot award) or an award that exceeds a certain threshold (e.g., an award exceeding $1,000), the system sends information about the award to the social network server to enable the server to create associated content (such as a screenshot of the outcome and associated award) and to post that content to the player's wall (or other suitable area) of the social networking website for the player's connections to see (and to entice them to play). In another embodiment, if a player joins a multiplayer game and there is another seat available, the system sends that information to the social network sever to enable the server to create associated content (such as text indicating a vacancy for that particular game) and to post that content to the player's wall (or other suitable area) of the social networking website for the player's connections to see (and to entice them to fill the vacancy). In another embodiment, if the player consents, the system sends advertisement information or offer information to the social network server to enable the social network server to create associated content (such as text or an image reflecting an advertisement and/or an offer) and to post that content to the player's wall (or other suitable area) of the social networking website for the player's connections to see. In another embodiment, the system enables the player to recommend a game to the player's connections by posting a recommendation to the player's wall (or other suitable area) of the social networking website.

Certain of the systems described herein, such as EGMs located in a casino or another gaming establishment, include certain components and/or are configured to operate in certain manners that differentiate these systems from general purpose computing devices, i.e., certain personal gaming devices such as desktop computers and laptop computers.

For instance, EGMs are highly regulated to ensure fairness and, in many cases, EGMs are configured to award monetary awards up to multiple millions of dollars. To satisfy security and regulatory requirements in a gaming environment, hardware and/or software architectures are implemented in EGMs that differ significantly from those of general purpose computing devices. For purposes of illustration, a description of EGMs relative to general purpose computing devices and some examples of these additional (or different) hardware and/or software architectures found in EGMs are described below.

At first glance, one might think that adapting general purpose computing device technologies to the gaming industry and EGMs would be a simple proposition because both general purpose computing devices and EGMs employ processors that control a variety of devices. However, due to at least: (1) the regulatory requirements placed on EGMs, (2) the harsh environment in which EGMs operate, (3) security requirements, and (4) fault tolerance requirements, adapting general purpose computing device technologies to EGMs can be quite difficult. Further, techniques and methods for solving a problem in the general purpose computing device industry, such as device compatibility and connectivity issues, might not be adequate in the gaming industry. For instance, a fault or a weakness tolerated in a general purpose computing device, such as security holes in software or frequent crashes, is not tolerated in an EGM because in an EGM these faults can lead to a direct loss of funds from the EGM, such as stolen cash or loss of revenue when the EGM is not operating properly or when the random outcome determination is manipulated.

Certain differences between general purpose computing devices and EGMs are described below. A first difference between EGMs and general purpose computing devices is that EGMs are state-based systems. A state-based system stores and maintains its current state in a non-volatile memory such that, in the event of a power failure or other malfunction, the state-based system can return to that state when the power is restored or the malfunction is remedied. For instance, for a state-based EGM, if the EGM displays an award for a game of chance but the power to the EGM fails before the EGM provides the award to the player, the EGM stores the pre-power failure state in a non-volatile memory, returns to that state upon restoration of power, and provides the award to the player. This requirement affects the software and hardware design on EGMs. General purpose computing devices are not state-based machines, and a majority of data is usually lost when a malfunction occurs on a general purpose computing device.

A second difference between EGMs and general purpose computing devices is that, for regulatory purposes, the software on the EGM utilized to operate the EGM has been designed to be static and monolithic to prevent cheating by the operator of the EGM. For instance, one solution that has been employed in the gaming industry to prevent cheating and to satisfy regulatory requirements has been to manufacture an EGM that can use a proprietary processor running instructions to provide the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used to operate a device during generation of the game of chance, can require burning a new EPROM approved by the gaming jurisdiction and reinstalling the new EPROM on the EGM in the presence of a gaming regulator. Regardless of whether the EPROM solution is used, to gain approval in most gaming jurisdictions, an EGM must demonstrate sufficient safeguards that prevent an operator or a player of an EGM from manipulating the EGM's hardware and software in a manner that gives him an unfair, and in some cases illegal, advantage.

A third difference between EGMs and general purpose computing devices is authentication-EGMs storing code are configured to authenticate the code to determine if the code is unaltered before executing the code. If the code has been altered, the EGM prevents the code from being executed. The code authentication requirements in the gaming industry affect both hardware and software designs on EGMs. Certain EGMs use hash functions to authenticate code. For instance, one EGM stores game program code, a hash function, and an authentication hash (which may be encrypted). Before executing the game program code, the EGM hashes the game program code using the hash function to obtain a result hash and compares the result hash to the authentication hash. If the result hash matches the authentication hash, the EGM determines that the game program code is valid and executes the game program code. If the result hash does not match the authentication hash, the EGM determines that the game program code has been altered (i.e., may have been tampered with) and prevents execution of the game program code.

A fourth difference between EGMs and general purpose computing devices is that EGMs have unique peripheral device requirements that differ from those of a general purpose computing device, such as peripheral device security requirements not usually addressed by general purpose computing devices. For instance, monetary devices, such as coin dispensers, bill validators, and ticket printers and computing devices that are used to govern the input and output of cash or other items having monetary value (such as tickets) to and from an EGM have security requirements that are not typically addressed in general purpose computing devices. Therefore, many general purpose computing device techniques and methods developed to facilitate device connectivity and device compatibility do not address the emphasis placed on security in the gaming industry.

To address some of the issues described above, a number of hardware/software components and architectures are utilized in EGMs that are not typically found in general purpose computing devices. These hardware/software components and architectures, as described below in more detail, include but are not limited to watchdog timers, voltage monitoring systems, state-based software architecture and supporting hardware, specialized communication interfaces, security monitoring, and trusted memory.

Certain EGMs use a watchdog timer to provide a software failure detection mechanism. In a normally-operating EGM, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to enable the operating software to set the timeout interval within a certain range of time. A differentiating feature of some circuits is that the operating software cannot completely disable the function of the watchdog timer. In other words, the watchdog timer always functions from the time power is applied to the board.

Certain EGMs use several power supply voltages to operate portions of the computer circuitry. These can be generated in a central power supply or locally on the computer board. If any of these voltages falls out of the tolerance limits of the circuitry they power, unpredictable operation of the EGM may result. Though most modern general purpose computing devices include voltage monitoring circuitry, these types of circuits only report voltage status to the operating software. Out of tolerance voltages can cause software malfunction, creating a potential uncontrolled condition in the general purpose computing device. Certain EGMs have power supplies with relatively tighter voltage margins than that required by the operating circuitry. In addition, the voltage monitoring circuitry implemented in certain EGMs typically has two thresholds of control. The first threshold generates a software event that can be detected by the operating software and an error condition then generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the EGM.

As described above, certain EGMs are state-based machines. Different functions of the game provided by the EGM (e.g., bet, play, result, points in the graphical presentation, etc.) may be defined as a state. When the EGM moves a game from one state to another, the EGM stores critical data regarding the game software in a custom non-volatile memory subsystem. This ensures that the player's wager and credits are preserved and to minimize potential disputes in the event of a malfunction on the EGM. In general, the EGM does not advance from a first state to a second state until critical information that enables the first state to be reconstructed has been stored. This feature enables the EGM to recover operation to the current state of play in the event of a malfunction, loss of power, etc. that occurred just before the malfunction. In at least one embodiment, the EGM is configured to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

To ensure the success of atomic transactions relating to critical information to be stored in the EGM memory before a failure event (e.g., malfunction, loss of power, etc.), memory that includes one or more of the following criteria be used: direct memory access capability; data read/write capability which meets or exceeds minimum read/write access characteristics (such as at least 5.08 Mbytes/sec (Read) and/or at least 38.0 Mbytes/sec (Write)). Memory devices that meet or exceed the above criteria may be referred to as “fault-tolerant” memory devices.

Typically, battery-backed RAM devices may be configured to function as fault-tolerant devices according to the above criteria, whereas flash RAM and/or disk drive memory are typically not configurable to function as fault-tolerant devices according to the above criteria. Accordingly, battery-backed RAM devices are typically used to preserve EGM critical data, although other types of non-volatile memory devices may be employed. These memory devices are typically not used in typical general purpose computing devices.

Thus, in at least one embodiment, the EGM is configured to store critical information in fault-tolerant memory (e.g., battery-backed RAM devices) using atomic transactions. Further, in at least one embodiment, the fault-tolerant memory is able to successfully complete all desired atomic transactions (e.g., relating to the storage of EGM critical information) within a time period of 200 milliseconds or less. In at least one embodiment, the time period of 200 milliseconds represents a maximum amount of time for which sufficient power may be available to the various EGM components after a power outage event has occurred at the EGM.

As described previously, the EGM may not advance from a first state to a second state until critical information that enables the first state to be reconstructed has been atomically stored. After the state of the EGM is restored during the play of a game of chance, game play may resume and the game may be completed in a manner that is no different than if the malfunction had not occurred. Thus, for example, when a malfunction occurs during a game of chance, the EGM may be restored to a state in the game of chance just before when the malfunction occurred. The restored state may include metering information and graphical information that was displayed on the EGM in the state before the malfunction. For example, when the malfunction occurs during the play of a card game after the cards have been dealt, the EGM may be restored with the cards that were previously displayed as part of the card game. As another example, a bonus game may be triggered during the play of a game of chance in which a player is required to make a number of selections on a video display screen. When a malfunction has occurred after the player has made one or more selections, the EGM may be restored to a state that shows the graphical presentation just before the malfunction including an indication of selections that have already been made by the player. In general, the EGM may be restored to any state in a plurality of states that occur in the game of chance that occurs while the game of chance is played or to states that occur between the play of a game of chance.

Game history information regarding previous games played such as an amount wagered, the outcome of the game, and the like may also be stored in a non-volatile memory device. The information stored in the non-volatile memory may be detailed enough to reconstruct a portion of the graphical presentation that was previously presented on the EGM and the state of the EGM (e.g., credits) at the time the game of chance was played. The game history information may be utilized in the event of a dispute. For example, a player may decide that in a previous game of chance that they did not receive credit for an award that they believed they won. The game history information may be used to reconstruct the state of the EGM before, during, and/or after the disputed game to demonstrate whether the player was correct or not in the player's assertion.

Another feature of EGMs is that they often include unique interfaces, including serial interfaces, to connect to specific subsystems internal and external to the EGM. The serial devices may have electrical interface requirements that differ from the “standard” EIA serial interfaces provided by general purpose computing devices. These interfaces may include, for example, Fiber Optic Serial, optically coupled serial interfaces, current loop style serial interfaces, etc. In addition, to conserve serial interfaces internally in the EGM, serial devices may be connected in a shared, daisy-chain fashion in which multiple peripheral devices are connected to a single serial channel.

The serial interfaces may be used to transmit information using communication protocols that are unique to the gaming industry. For example, IGT's Netplex is a proprietary communication protocol used for serial communication between EGMs. As another example, SAS is a communication protocol used to transmit information, such as metering information, from an EGM to a remote device. Often SAS is used in conjunction with a player tracking system.

Certain EGMs may alternatively be treated as peripheral devices to a casino communication controller and connected in a shared daisy chain fashion to a single serial interface. In both cases, the peripheral devices are assigned device addresses. If so, the serial controller circuitry must implement a method to generate or detect unique device addresses. General purpose computing device serial ports are not able to do this.

Security monitoring circuits detect intrusion into an EGM by monitoring security switches attached to access doors in the EGM cabinet. Access violations result in suspension of game play and can trigger additional security operations to preserve the current state of game play. These circuits also function when power is off by use of a battery backup. In power-off operation, these circuits continue to monitor the access doors of the EGM. When power is restored, the EGM can determine whether any security violations occurred while power was off, e.g., via software for reading status registers. This can trigger event log entries and further data authentication operations by the EGM software.

Trusted memory devices and/or trusted memory sources are included in an EGM to ensure the authenticity of the software that may be stored on less secure memory subsystems, such as mass storage devices. Trusted memory devices and controlling circuitry are typically designed to not enable modification of the code and data stored in the memory device while the memory device is installed in the EGM. The code and data stored in these devices may include authentication algorithms, random number generators, authentication keys, operating system kernels, etc. The purpose of these trusted memory devices is to provide gaming regulatory authorities a root trusted authority within the computing environment of the EGM that can be tracked and verified as original. This may be accomplished via removal of the trusted memory device from the EGM computer and verification of the secure memory device contents is a separate third party verification device. Once the trusted memory device is verified as authentic, and based on the approval of the verification algorithms included in the trusted device, the EGM is enabled to verify the authenticity of additional code and data that may be located in the gaming computer assembly, such as code and data stored on hard disk drives.

In at least one embodiment, at least a portion of the trusted memory devices/sources may correspond to memory that cannot easily be altered (e.g., “unalterable memory”) such as EPROMS, PROMS, Bios, Extended Bios, and/or other memory sources that are able to be configured, verified, and/or authenticated (e.g., for authenticity) in a secure and controlled manner.

According to one embodiment, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment, the remote device and the trusted information source may engage in methods using zero knowledge proofs to authenticate each of their respective identities.

EGMs storing trusted information may utilize apparatuses or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Mass storage devices used in a general purpose computing devices typically enable code and data to be read from and written to the mass storage device. In a gaming environment, modification of the gaming code stored on a mass storage device is strictly controlled and would only be enabled under specific maintenance type events with electronic and physical enablers required. Though this level of security could be provided by software, EGMs that include mass storage devices include hardware level mass storage data protection circuitry that operates at the circuit level to monitor attempts to modify data on the mass storage device and will generate both software and hardware error triggers should a data modification be attempted without the proper electronic and physical enablers being present.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary, a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention claimed is:

1. A system comprising:
a processor; and
a memory device that stores a plurality of instructions that, when executed by the processor, cause the processor to:
maintain a progressive award,
cause, in a distributed ledger, an association of a first token with the maintained progressive award, and
responsive to an occurrence of a progressive award increment event, cause, in the distributed ledger, a modification associated with the first token.

2. The system of claim 1, wherein the first token comprises a first fungible token and the modification associated with the first token comprises a modification of an attribute of the first fungible token.

3. The system of claim 1, wherein the first token comprises a first non-fungible token.

4. The system of claim 3, wherein the modification associated with the first token comprises a creation, in the distributed ledger, of a second non-fungible token based on the first non-fungible token, a disassociation, in the distributed ledger, of the first non-fungible token from the progressive award and an association, in the distributed ledger, of the second non-fungible token with the progressive award.

5. The system of claim 3, wherein the modification associated with the first token comprises a creation, in the distributed ledger, of a second non-fungible token associated with an attribute of the first non-fungible token, a creation, in the distributed ledger, of a third non-fungible token based on a combination of the first non-fungible token and the second non-fungible token, a disassociation, in the distributed ledger, of the first non-fungible token from the progressive award and an association, in the distributed ledger, of the third non-fungible token with the progressive award.

6. The system of claim 1, wherein the progressive award is associated with an amount of cryptocurrency.

7. The system of claim 1, wherein the memory device stores a plurality of further instructions that, when executed by the processor responsive to an occurrence of a progressive award triggering event, cause the processor to cause, in the distributed ledger, an ownership change of the token to a user associated with the occurrence of the progressive award triggering event.

8. The system of claim 1, wherein the progressive award increment event occurs when a value of the progressive award reaches a threshold value.

9. The system of claim 1, wherein the memory device stores a plurality of further instructions that, when executed by the processor responsive to the occurrence of the progressive award increment event, cause the processor to enable a user to select the modification associated with the first token.

10. A system comprising:
a processor; and
a memory device that stores a plurality of instructions that, when executed by the processor, cause the processor to:
maintain a progressive award,
at a first point in time, cause a display, by a display device, of a first non-fungible token associated, in a distributed ledger, with the progressive award, and
at a second, subsequent point in time, cause a display, by the display device, of a second non-fungible token associated, in the distributed ledger, with the progressive award, wherein the second non-fungible token replaces, in the distributed ledger, the association of the first non-fungible token with the progressive award.

11. The system of claim 10, wherein the second, subsequent point in time occurs in association with a value of the progressive award reaching at least a threshold value following an occurrence of a progressive award increment event.

12. A method of operating a system, the method comprising:
maintaining, by a processor, a progressive award,
causing, by the processor and in a distributed ledger, an association of a first token with the maintained progressive award, and
responsive to an occurrence of a progressive award increment event, causing, by the processor and in the distributed ledger, a modification associated with the first token.

13. The method of claim 12, wherein the first token comprises a first fungible token and the modification associated with the first token comprises a modification of an attribute of the first fungible token.

14. The method of claim 12, wherein the first token comprises a first non-fungible token.

15. The method of claim 14, wherein the modification associated with the first token comprises a creation, in the distributed ledger, of a second non-fungible token based on the first non-fungible token, a disassociation, in the distributed ledger, of the first non-fungible token from the progressive award and an association, in the distributed ledger, of the second non-fungible token with the progressive award.

16. The method of claim 14, wherein the modification associated with the first token comprises a creation, in the distributed ledger, of a second non-fungible token associated with an attribute of the first non-fungible token, a creation, in the distributed ledger, of a third non-fungible token based on a combination of the first non-fungible token and the second non-fungible token, a disassociation, in the distributed ledger, of the first non-fungible token from the progressive award and an association, in the distributed ledger, of the third non-fungible token with the progressive award.

17. The method of claim 12, wherein the progressive award is associated with an amount of cryptocurrency.

18. The method of claim 12, further comprising, responsive to an occurrence of a progressive award triggering event, causing, by the processor and in the distributed ledger, an ownership change of the token to a user associated with the occurrence of the progressive award triggering event.

19. The method of claim 12, wherein the progressive award increment event occurs when a value of the progressive award reaches a threshold value.

20. The method of claim 12, wherein the memory device stores a plurality of further instructions that, when executed by the processor responsive to the occurrence of the progressive award increment event, cause the processor to enable a user to select the modification associated with the first token.
